(19) United States
(12) Patent Application Publication
(10) Pub. No.: US 2003/0144773 A1
(43) Pub. Date: Jul. 31, 2003

(54) Control unit for hybrid vehicle

(76) Inventor: Tatsuya Sumitomo, Shizuoka (JP)

Correspondence Address: KNOBBE MARTENS OLSON & BEAR LLP, 2040 MAIN STREET, FOURTEENTH FLOOR, IRVINE, CA, 92614, US

(21) Appl. No.: 10/331,436

(22) Filed: Dec. 27, 2002

(30) Foreign Application Priority Data
Dec. 27, 2001 (JP) 2001-397416
Dec. 28, 2001 (JP) 2001-401700
Dec. 28, 2001 (JP) 2001-401701
Dec. 28, 2001 (JP) 2001-401702
Jan. 28, 2002 (JP) 2002-018155

(51) Int. Cl. B60L 11/00

(52) U.S. Cl. 701/22; 180/65.3

(57) ABSTRACT

A hybrid vehicle includes an electric motor and an internal combustion engine, and can operate in an independent electric motor drive mode and a hybrid drive mode. For this purpose, the vehicle also includes a control unit that controls the operation of the electric motor and the internal combustion engine. The control unit comprises a controller and a plurality of sensors providing information relating to vehicle operation. The controller preferably controls the drive force produced by the motor to reduce the jolt experienced by the vehicle when the engine is engaged during the hybrid drive mode, thereby reducing driver discomfort. Additionally, the controller controls the charging of the battery during all modes of vehicle operation and adequately controls the ratio of the drive force from the motor and the engine that is transmitted to the drive wheels. The controller also preferably controls the increased recovery of kinetic energy from the harnessing of the inertia of the engine during engine shut-off to generate electric power to charge the battery.

### RELATED CASES

This application is based on and claims priority to Japanese Patent Application Nos. JP2001-397416, filed Dec. 27, 2001, JP2001-401700, JP2001-401701, and JP2001-401702, filed Dec. 28, 2001, and JP2002-018155, filed Jan. 28, 2002, the entire contents of which are hereby incorporated by reference.

### BACKGROUND OF THE INVENTION

1. Field of the Invention

The invention is directed at a hybrid vehicle. Specifically, the invention relates to an operation control device for a hybrid vehicle.

2. Description of the Related Art

Hybrid vehicle designs have been proposed in which a battery provides an electric motor with electric power to generate a drive force. The motor then transmits the drive force to the drive wheels through a transmission to propel the vehicle. An internal combustion engine is used to drive a generator to charge the battery.

In such conventional vehicle designs, only the electric motor generates the drive force to drive the drive wheels and propel the vehicle. Therefore, the electric motor must be sized sufficiently large to generate a drive force that can maintain a set vehicle speed when a large external load is applied, for example during a hill climb.

In other conventional vehicle designs, use of the internal combustion engine in addition to the electric motor to propel the vehicle has been proposed. In such vehicles, the electric motor drives the drive wheels when a low external load is applied to the vehicle. Alternatively, both the electric motor and the engine drive the drive wheels when a high external load is applied.

In other designs, the electric motor operates as a generator that generates electric power during speed reduction of the vehicle by recovering kinetic energy from the inertial movement of the vehicle body. The electric power generated using the recovered kinetic energy is used to charge the battery.

### SUMMARY OF THE INVENTION

As noted above, some conventional hybrid vehicle designs only use an electric motor to drive the drive wheels and propel the vehicle. Accordingly, one aspect of the present invention is the recognition that a second power source, such as an internal combustion engine, can be used in conjunction with the first power source (e.g., electric motor) to drive the drive wheels. Moreover, another aspect of the present invention is the recognition that when the second power source is engaged to drive the drive wheels, the vehicle will experience a jolt due to the increase in drive force, resulting in driver discomfort. Accordingly, in one embodiment, a control unit for the hybrid vehicle reduces a jolt caused by engaging a second power source to drive the drive wheels of the vehicle in conjunction with a first power source. In another embodiment, a variable transmission is used to reduce the jolt caused by engaging the second power source.

In the conventional hybrid vehicle design, an engine is used to charge the battery through a generator when the residual battery capacity is below a setpoint. However, in vehicle designs that use both the motor and the engine to drive the drive wheels, the engine does not operate when the vehicle is stopped or when a low external load is applied to the vehicle. Accordingly, another aspect of the present invention is the recognition that in such hybrid vehicle designs, a source for charging the battery when the vehicle is stopped or a low load is applied to the vehicle is required. Yet another aspect of the present invention is the recognition that if the engine driven generator is used to charge the battery when a low external load is applied to the vehicle, it is necessary to prevent the engine from interfering with the propulsion of the vehicle. Still another aspect of the present invention is the recognition that the engine generates noise when used to charge the battery or when idling while the vehicle is driven solely by the electric motor. Therefore, in another embodiment, a control unit is provided to charge a battery with an engine-driven generator through the entire operational range of the vehicle, without interfering with the propulsion of the vehicle and can be shut-off if not required to either propel the vehicle or charge the battery. Moreover, the electric motor can be used to charge the battery under certain operating conditions and the use of the engine to charge the battery is controlled to minimize noise during operation of the vehicle.

As noted above, some conventional hybrid vehicle designs use two power sources, generally an electric motor and an internal combustion engine, to drive the drive wheels of the vehicle during a hybrid vehicle travel mode. Another aspect of the present invention is the recognition that in the hybrid vehicle drive mode, the ratio of the drive force from the first power source relative to the drive force from the second power source must be controlled. Additionally, another aspect of the present invention is the recognition that when a second power source, e.g., an engine, is used to charge the battery through a generator while the vehicle operates in the hybrid vehicle travel mode, the ratio of the drive force from the second power source to the generator relative to the drive force from the second power source to the drive wheels must be controlled. Accordingly, in another embodiment, a control unit is provided that is capable of adequately controlling the ratio of the drive force from a first power source relative to the drive force from a second power source. The control unit is further capable of adequately controlling the ratio of the drive force from a second power source to a generator relative to the drive force from the second power source to the drive wheels.

As described above, in some hybrid vehicle designs, the electric motor operates as a generator to generate electric power during slowdown of the vehicle. However, in order to reduce the amount of fuel consumed by the engine to charge the battery, increased recovery of kinetic energy during vehicle slowdown is required. Accordingly, another aspect of the present invention is the recognition that an increased amount of kinetic energy can be recovered from the vehicle by recovering kinetic energy from the inertial movement of the engine components following shut-off of the engine. Therefore, in another embodiment, a control unit is provided that reduces the fuel consumed by the engine to charge the battery by harnessing the kinetic energy from the engine during shut-off of the engine.

Embodiments and advantages other than those described herein will be apparent to one of ordinary skill in the art.

### BRIEF DESCRIPTION OF THE DRAWINGS

FIG. 1 is a side view of a hybrid type vehicle configured in accordance with a preferred embodiment of the present invention.

FIG. 2 is a block diagram of a drive system and control system for the vehicle illustrated in FIG. 1, in accordance with a first preferred embodiment of the invention.

FIG. 3a is a graph showing the driving torque characteristics of the hybrid vehicle illustrated in FIG. 2.

FIG. 3b is a graph showing the driving torque characteristics of the hybrid vehicle illustrated in FIG. 2.

FIG. 4 is a block diagram of the vehicle drive and control systems configured in accordance with a second preferred embodiment of the hybrid vehicle.

FIG. 5 is a block diagram of the vehicle drive and control systems configured in accordance with a third preferred embodiment of the hybrid vehicle.

FIG. 6 is a flow chart describing the operation of the vehicle drive and control systems configured in accordance with the third embodiment.

FIG. 7 is a block diagram of a modification to the third embodiment of the drive and control systems for the hybrid vehicle.

FIG. 8 is block diagram of a modification to the third embodiment of the drive and control systems for the hybrid vehicle illustrated in FIG. 5.

FIG. 9 is a flow chart describing the operation of the vehicle drive and control systems configured in accordance with the third embodiment illustrated in FIG. 8.

FIG. 10 is a block diagram of a further modification to the third embodiment of the drive and control systems for the hybrid vehicle illustrated in FIG. 7.

FIG. 11 is a block diagram illustrating the rear wheel drive system, according to the third embodiment of the hybrid vehicle illustrated in FIG. 5.

FIG. 12 is a block diagram illustrating a modification to the rear wheel drive system, according to the third embodiment of the hybrid vehicle illustrated in FIG. 5.

FIG. 13 is a block diagram illustrating a further modification to the rear wheel drive system, according to the third embodiment of the hybrid vehicle illustrated in FIG. 5.

FIG. 14 is a block diagram of the vehicle drive and control systems configured in accordance with a fourth preferred embodiment of the hybrid vehicle.

FIG. 15 is a flowchart describing the operation of the vehicle according to the fourth embodiment.

FIG. 16 is a graph illustrating the residual capacity of the battery as a function of a ratio of the drive force from the electric motor relative to the drive force from the engine that is transmitted to the drive wheels, according to the fourth embodiment.

FIG. 17 is a flow-chart describing the operation of the vehicle according to the fourth embodiment.

FIG. 18 is a graph illustrating the residual capacity of the battery as a function of a ratio of the drive force transmitted to the generator relative to a drive force transmitted to the drive wheels, according to the fourth embodiment.

FIG. 19 is a graph illustrating the sum of the drive forces from the electric motor and the engine as a function of the difference between a detected vehicle speed and a target vehicle speed, according to the fourth embodiment.

FIG. 20 is a block diagram the vehicle drive and control systems configured in accordance with a fifth preferred embodiment of the hybrid vehicle.

FIG. 21 is a block diagram illustrating the rear wheel drive system, according to the fifth embodiment.

FIG. 22 is a graph illustrating the charge rate of the battery according to the fifth embodiment.

FIG. 23 is a graph illustrating the change in load on the electric motor according to the fifth embodiment.

FIG. 24 is a schematic diagram illustrating the operation of the hybrid vehicle from a top plan view.

FIG. 25 is a schematic diagram illustrating the operation of the hybrid vehicle from a side view.

### DETAILED DESCRIPTION OF THE PREFERRED EMBODIMENTS

In the following description, reference is made to the accompanying drawings, which form a part hereof, and which show, by way of illustration, specific embodiments and control methods and routines in which various aspects and features of the invention may be practiced. Where possible, the same reference numbers are used throughout the drawings and following description to refer to the same or like components among the embodiments.

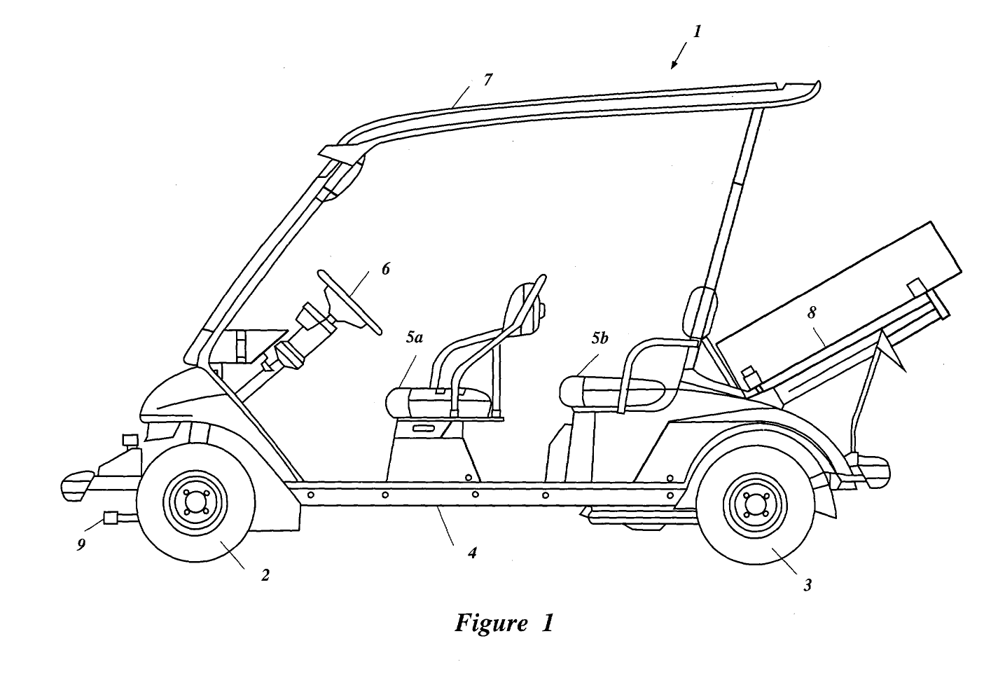

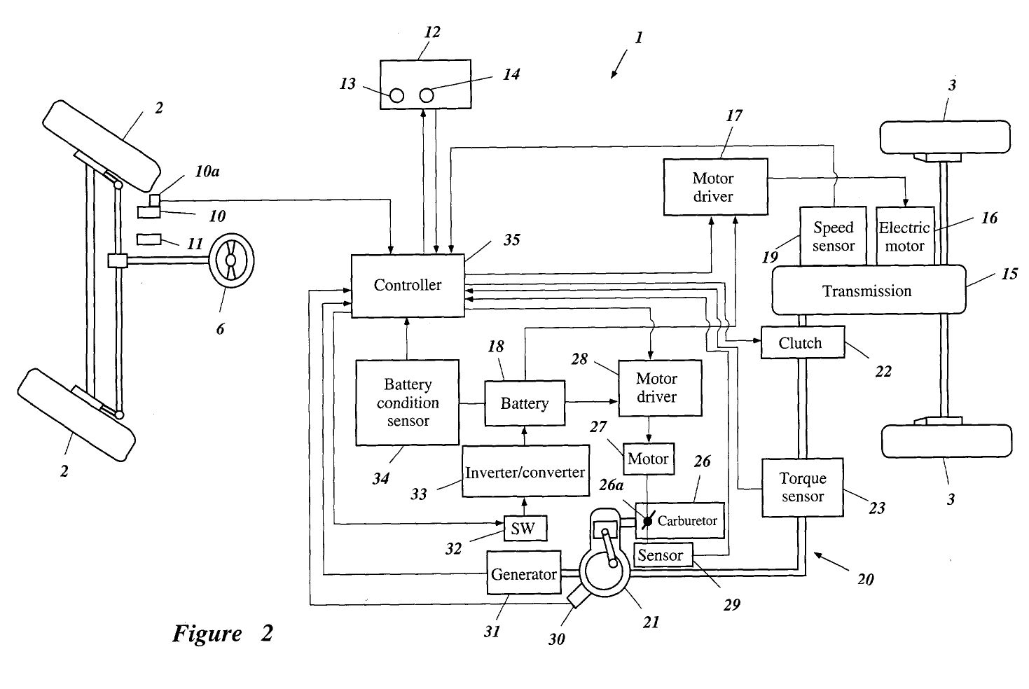

With reference to FIGS. 1 and 2, a hybrid vehicle 1 generally comprises a plurality of wheels disposed under and supported by a chassis 4. In the illustrated embodiment, the plurality of wheels includes two front wheels 2 and two rear wheels 3. The vehicle 1 further comprises at least one seat, preferably a front seat 5a and a rear seat 5b, and a steering mechanism connected to the chassis 4. The steering mechanism preferably is a steering wheel 6. The vehicle optionally comprises a roof 7 and a carrying compartment 8 that is also attached to the chassis 4. A pilot wire detection sensor 9 is preferably disposed in front of the front wheels 2 and is configured to detect a pilot wire (not shown) on a vehicle 1 travel course (not shown).

The vehicle 1, further comprises a hybrid engine with two power supply sources (i.e., prime movers). At least one of the plurality of wheels is configured to be selectively driven by the power supply sources to propel the vehicle 1. In the illustrated embodiment, the rear wheels 3 are configured to be selectively driven by the power supply sources. The power supply sources may be any power supply source. For example, the two power supply sources in the illustrated embodiment are an electric motor and an internal combustion engine. As such, the vehicle 1 also comprises an ignition system and a fuel supply system, although these systems are not illustrated in FIG. 1.

With reference to FIG. 2, a block diagram of one embodiment of the hybrid vehicle is illustrated. According to the present embodiment, the front wheels 2 are connected to each other through a front axle. The front wheels 2 are further connected to the steering wheel 6 through a steering linkage assembly and a steering shaft. A throttle-input source and a brake-input source preferably are disposed near the juncture of the steering shaft to the steering linkage assembly, so as to be easily operated by a driver. In the illustrated embodiment, the throttle-input source and the brake-input source are an acceleration pedal 10 and a brake pedal 11, respectively. Both pedals 10, 11 are configured to be displaces when pressed by the driver. A throttle command sensor 10a is disposed adjacent to the acceleration pedal 10. The sensor 10a is configured to detect a displacement of the pedal 10 by the driver and to communicate a throttle-command signal corresponding to the displacement.

A control panel 12 has a main switch 13 and a mode selection switch 14, wherein both switches 13, 14 are configured to receive an input from a user and, based on the input, select the operation of the vehicle 1 to be a manual travel mode or an automatic travel mode. The switches 13, 14 are further configured to communicate a driving mode signal. The panel 12 is preferably disposed on the vehicle 1 body. For example, the panel 12 may be attached to the chassis 4. Alternatively, the panel 12 may be disposed in a remote location.

According to the present embodiment, the rear wheels 3 (herein after referred to as the drive wheels) are configured to be selectively driven by two power supply sources. The drive wheels 3 are connected together by a rear axle. The rear axle connects to an output shaft of a transmission 15, and is configured to transmit a drive force from the transmission 15 to the wheels 3.

An input shaft of the transmission 15 connects to an electric motor 16, which is one of the two power supply sources in the illustrated embodiment. The motor 16 is configured to generate a drive force (i.e., a motor drive force) and to rotate the input shaft of the transmission 15 with said drive force. A motor drive force transmission system disposed between the motor 16 and the transmission 15 is configured to transmit the drive force from the motor 16 to the wheels 3 through the transmission 15.

A motor driver 17 is connected to the motor 16 and is configured to transmit electric power to the motor 16 from a battery 18. The motor driver 17 is further configured to receive a control signal for operating the motor 16. The battery 18 supplies electric power to the motor driver 17.

A vehicle speed sensor 19 is disposed so as to detect the revolution of the output shaft of the transmission 15, which is representative of vehicle 1 speed. The sensor 19 is further configured to communicate a vehicle speed signal corresponding to the detected vehicle speed. Other types of vehicle speed sensors, however, can also be used.

An engine drive force transmission system 20, which comprises a transmission device, is disposed between an internal combustion engine 21 and the transmission 15. The engine 21 is the second of the two power supply sources in the illustrated embodiment. Other types of primary movers may also be used as the second of the two power sources in the illustrated embodiment. The transmission system 20 is configured to transmit a drive force generated by the engine 21 (i.e., engine drive force) from the transmission device to the wheels 3 through the transmission 15. The transmission device can, for example, include a chain, a drive sprocket and a driven sprocket, wherein the chain wraps around the sprockets. In another example, the transmission device can include a drive pulley and a driven pulley, where a belt wraps around the pulleys. In yet another example, the transmission device can include a drive shaft. In still another example, the transmission device can include gears. Further, these devices are not mutually exclusive, so the transmission device can include a combination of the devices described above.

A clutch 22 is disposed along the transmission system 20 between the engine 21 and the transmission 15 and is configured to receive a control signal. The clutch 22 is preferably an electromagnetic clutch. The clutch 22 is optionally configured to operate as a one-way clutch, capable of transmitting the drive force from the engine 21 to the drive wheels 3 but incapable of transmitting a drive force from the drive wheels 3 to the engine 21. A drive force sensor 23 is also disposed along the transmission system 20, preferably between the clutch 22 and the engine 21, and is configured to detect the drive force transmitted from the engine 21 to the transmission 15. In the illustrated embodiment, the drive force corresponds to torque and the drive force sensor is preferably a torque sensor 23 that detects drive torque transmitted from the engine 21 to the transmission 15.

The engine 21 generally comprises an engine body, a crankshaft, and a piston. The engine 21 also includes a carburetor 26. It is understood that instead of the carburetor 26 shown in the illustrated embodiment, the engine 21 may alternatively be fuel injected. The carburetor 26 comprises a throttle valve 26a and is configured to supply the engine 21 with a fuel charge including fuel from the fuel supply system. The fuel charge is a mixture of fuel and air. A throttle motor 27 is connected to the carburetor 26 and is configured to adjust the position of the throttle valve 26a. A motor driver 28 drives the throttle motor 27. The motor driver 28 is also connected to the battery 18 and receives a control signal for operating the engine 21. Additionally, a throttle valve sensor 29 is disposed proximally to the carburetor 26. The sensor 29 detects the throttle valve 26a position and outputs a signal that corresponds to said throttle valve 26a position. Further, an engine speed sensor 30 detects the crankshaft speed and outputs a signal corresponding to the crankshaft speed. The speed sensor 30 is disposed adjacent to the engine 21.

The crankshaft of the engine 21 connects to a generator 31. The generator 31 is configured to receive a drive force from the engine 21 through the rotation of the crankshaft and to generate a corresponding amount of electric power. The generator 31 is also configured to communicate current and voltage values associated with the generator's production. The generator 31 is further configured to transmit the electric power to the battery 18 through a switch 32 and an inverter/converter (i.e., a rectifier) 33. The switch 32 receives a control signal and selectively allows the transmission of the electric power from the generator 31 to the battery 18. Additionally, the inverter/converter 33 is configured to convert electric power from one form to another. For example, the inverter/converter 33 converts an alternating current generated by the generator 31 to a direct current for use by the battery 18.

A battery condition sensor 34 communicates with the battery 18 and detects a residual capacity of the battery 18. The sensor 34 is further configured to communicate a signal corresponding to said residual battery capacity

In the illustrated embodiment, a controller 35 disposed in the vehicle 1 is configured to communicate with the throttle sensor 10a, the main switch 13 and the mode selection switch 14, the vehicle speed sensor 19, the motor drivers 17, 28, the clutch 22, the throttle valve sensor 29, the engine speed sensor 30, the generator 31, the switch 32 and the battery condition sensor 34.

Specifically, the controller 35 is configured to receive a throttle-command signal from the throttle sensor 10a and a driving mode signal from the main switch 13 and the mode selection switch 14. The controller 35 is also configured to receive a vehicle speed signal from the vehicle speed sensor 19. Further, the controller 35 is configured to transmit a control signal to the motor drivers 17, 28, the clutch 22, and the switch 32. Additionally, the controller 35 is configured to receive a throttle valve position signal from the throttle valve sensor 29, a crankshaft speed signal from the engine speed sensor 30, current and voltage signals from the generator 31, and a residual battery capacity signal from the battery condition sensor 34.

In the embodiment illustrated in FIG. 2, during operation, a driver opts to operate the vehicle 1 in the manual travel mode or the automatic travel mode by using the main switch 13 and the mode selection switch 14 on the control panel 12 to generate the driving mode signal. The driving mode signal is then communicated to the controller 35.

In the manual travel mode, the driver uses the acceleration pedal 10, the brake pedal 11 and the steering wheel 6 to operate the vehicle 1. The driver presses the acceleration pedal 10 when the external load on the vehicle 1 increases, for example during uphill travel, or if the driver intends to accelerate the vehicle 1. The throttle sensor 10a generates the throttle-command signal corresponding to the displacement of the pedal 10 and communicates the throttle-command signal to the controller 35. The controller 35 receives the throttle-command signal and calculates a corresponding load requirement on the vehicle 1. Accordingly, the throttle sensor 10a functions as a load sensor.

In the automatic travel mode, the driver does not operate the accelerator pedal 10 so the controller 35 does not receive a throttle-command signal corresponding to the detected pedal 10 displacement. Instead, the vehicle 1 travels along a pilot wire (not shown). However, in the automatic travel mode a detected vehicle speed V1 detected by the vehicle speed sensor 19 varies in response to changes in the external load on the vehicle 1. That is, the load requirement on the vehicle 1 corresponds to the difference between a target vehicle speed V0, received by the controller from the pilot wire via the pilot wire detection sensor 9, and the detected vehicle speed V1. The load requirement thus increases with an increase in the difference between the target speed V0 and detected speed V1 (i.e., V0−V1) and decreases with a decrease in said difference. Thus if the detected vehicle speed V1 is lower than the target vehicle speed V0, a vehicle speed control signal corresponding to the difference between the detected speed V1 and target speed V0 is generated by the controller 35. The controller 35 uses the vehicle speed control signal to calculate the corresponding load requirement on the vehicle. Accordingly, the vehicle speed sensor 19 functions as a load sensor.

The controller 35 controls the operation of the motor 16 and the engine 21 based on the load requirement the controller 35 calculates corresponding to the throttle-command signal or vehicle speed control signal on the actual speed of the vehicle (hereinafter collectively referred to as “the commanded load”). If the commanded load is lower than a load setpoint, the controller 35 preferably controls the motor 16 and the engine 21 so that only the motor 16 drives the drive wheels 3. That is, the vehicle 1 operates in an independent electric motor drive mode. Alternatively, if the load is greater than the load setpoint, the controller 35 preferably controls the motor 16 and the engine 21 so that both the motor 16 and the engine 21 drive the wheels 3. That is, the vehicle 1 operates in a hybrid drive mode.

Specifically, in the independent drive mode, the motor 16 drives the wheels 3 while the engine 21 remains shut-off. The controller 35 communicates a control signal to the motor driver 17 in response to the calculated load to increase the power supply from the battery 18 to the motor 16. The motor 16 generates an increased drive force in response to the increased power supply and transmits the drive force to the drive wheels 3 through the motor drive force transmission system to propel the vehicle 1. Preferably, the controller 35 communicates an OFF signal to the clutch 22 to disengage the clutch 22 from the engine drive force transmission system 20. Disengagement of the clutch 22 prevents transmission of the rotational torque from the drive wheels 3 to the engine 21 through the transmission system 20, thereby preventing the engine 21 from operating as a brake by resisting against the propulsion of the vehicle 1.

However, during vehicle operation where it is advantageous for the engine 21 to operate as a brake, such as when traveling down-hill, the controller 35 preferably communicates an ON signal to the clutch 22 to engage the clutch 22 with the engine drive force transmission system 20. Therefore, the engine 21 may be operated as a brake as required by vehicle driving conditions.

If the controller 35 calculates a load equal to or greater than the load setpoint, the controller 35 communicates a start-up signal to the ignition system. The ignition system actuates a starter motor connected to the crankshaft of the engine 21 to rotate the crankshaft and start the engine 21. The fuel supply system operation also starts. The engine speed sensor 30 communicates a crankshaft speed signal to the controller 35 corresponding to the engine speed. In the illustrated embodiment, once the crankshaft speed signal is greater than a crankshaft speed setpoint that defines engine start-up, the controller 35 registers start-up of the engine. It should be noted that the crankshaft speed setpoint is preferably greater than the speed at which the starter motor initially rotates the crankshaft. Other types of engine start-up sensors, such as, for example, a starter motor sensor, can also be used. Accordingly, the engine speed sensor 30 functions as an engine start-up sensor.

Upon registering start-up, the controller 35 communicates a control signal to the throttle motor driver 28 in response to the calculated load to increase the engine drive force produced by the engine 21. Accordingly, the throttle motor driver 28 drives the throttle motor 27 to adjust the position of the throttle valve 26a on the carburetor 26 in response to the control signal from the controller 35. The carburetor 26 delivers an increased fuel charge to the engine 21, including an increased amount of fuel from the fuel supply system, corresponding to the adjusted throttle valve 26a position. As a result, the engine 21 generates an increased drive force in response to the increased amount of fuel and transmits the drive force to the wheels 3 through the engine drive force transmission system 20 to propel the vehicle 1.

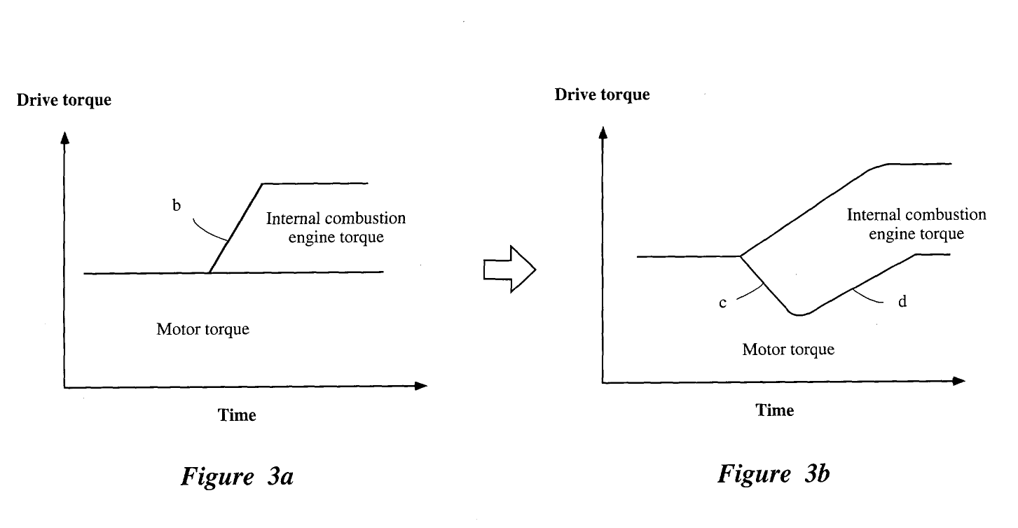

With reference to FIGS. 3a and 3b, operation of the vehicle 1 according to the present embodiment is illustrated therein. After the engine 21 is started, if the drive force sensor 23 detects the drive force transmitted by the engine 21 increasing at a rate equal to or greater than a first predetermined rate, as illustrated by “b” in FIG. 3a, the controller 35 communicates a control signal to the motor driver 17 to regulate the power supplied from the battery 18 to the motor 16 so that the drive force generated by the motor 16 decreases gradually at a predetermined rate, as illustrated by “c” in FIG. 3b. Accordingly, the overall combined drive force from the motor 16 and the engine 21 increases gradually to prevent driver discomfort.

Furthermore, if the drive force sensor 23 detects the drive force transmitted by the engine 21 increasing at a rate equal to or lower than a second predetermined rate, which is preferably lower than the first predetermined rate, the controller 35 communicates a signal to the motor driver 17 to increase the power supplied by the battery 18 to the motor 16 to increase the drive force generated by the motor 16, as illustrated by “d” in FIG. 3b.

Accordingly, if the vehicle 1 accelerates so that the drive force transmitted by the engine 21 increases at a rate greater than the first predetermined rate, the controller 35 controls the operation of the motor 16 such that the drive force generated by the motor 16 decreases at a predetermined rate. However, if the speed of the engine 21 subsequently decreases so that the drive force transmitted by the engine 21 increases at a rate equal to or lower than the second predetermined rate, which is lower than the first predetermined rate, the controller 35 controls the operation of the motor 16 so that the drive force transmitted by the motor 16 to the drive wheels 3 increases, as illustrated by “d” in FIG. 3b.

Alternatively, when the controller 35 registers the start-up of the engine 21, the controller 35 communicates a control signal to the motor driver 17 to regulate the power supplied to the motor 16 so that the drive force generated by the motor 16 decreases gradually at a predetermined rate for a predetermined period of time. After the predetermined period of time has elapsed, the controller 35 communicates a control signal to the motor driver 17 to regulate the operation of the motor 16 so that the drive force generated by the motor 16 increases gradually back to the drive force corresponding to the load. Therefore, according to this aspect of the present embodiment, the controller 35 may control the operation of the motor 16 and the engine 21 to reduce driver discomfort without a drive force sensor 23.

Additionally, if the vehicle speed sensor 19 detects a vehicle speed below a target vehicle speed, which may differ from the target vehicle speed V0, when the engine 21 is started, the controller 35 controls the operation of the motor 16 such that the predetermined rate of decrease of the drive force generated by the motor 16 is set higher than if the vehicle speed was equal to or greater than the target vehicle speed. Thus, further reduction in driver discomfort caused by engaging the engine 21 at lower vehicle speed is attained.

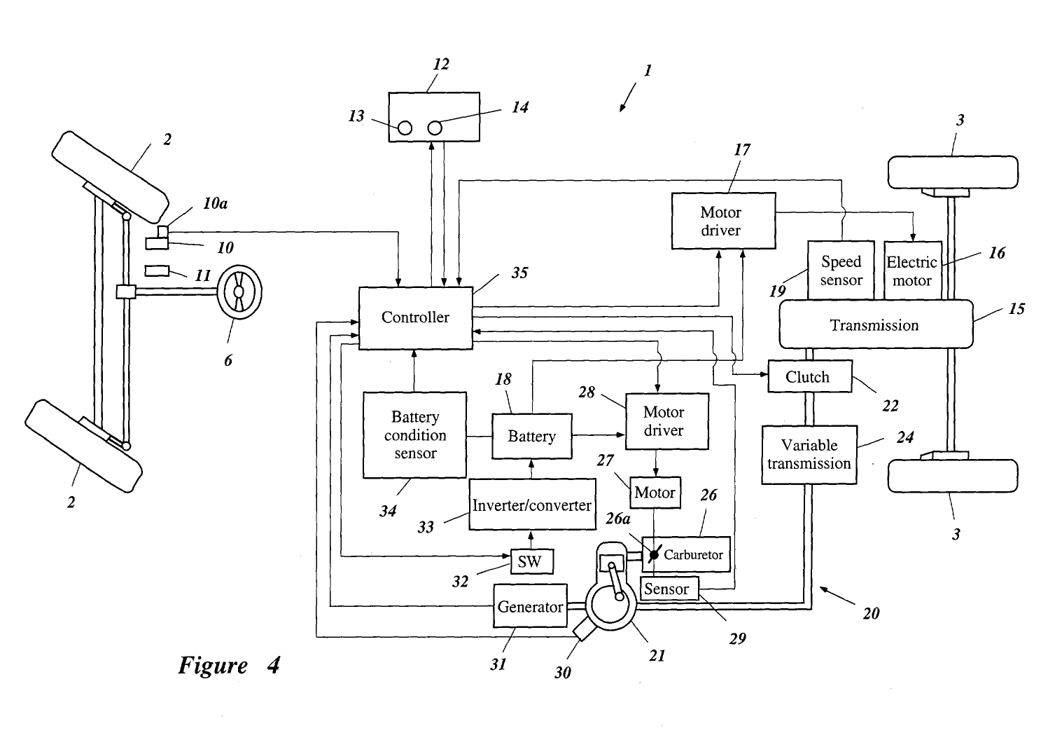

With reference to FIG. 4, a second embodiment of the present hybrid vehicle is illustrated therein. Components of the vehicle 1 that are similar to the corresponding components illustrated in FIG. 2 are identified with the same reference numeral, while dissimilar components are identified with a prime symbol (e.g., “‘32’”).

According to a second embodiment of the present invention, a continuously variable transmission 24 is disposed along the drive force transmission system 20, preferably between the clutch 22 and the internal combustion engine 21. The variable transmission 24 is preferably a V-belt type continuously variable transmission and comprises a drive pulley, a driven pulley, and a V-belt. The drive pulley connects to the output shaft (e.g., the crankshaft) of the engine 21 and the driven pulley connects to the input shaft of the transmission 15. The V-belt wraps around the drive pulley and the driven pulley. Additionally a switch 32′ is disposed between the generator 31 and the battery 18, preferably before the inverter/converter 33. The switch 32′ is configured to selectively allow transmission of electric power from the generator 31 to the battery 18.

In the present embodiment, when the controller 35 calculates a load equal to or greater than a predetermined value, so that the ignition system actuates the starter motor to start the engine 21, the variable transmission 24 reduces the engine drive force transmitted from the engine 21 to the drive wheels 3 by slipping the V-belt between the drive pulley and the driven pulley. Therefore, according to the second embodiment of the present invention, a continuously variable transmission 24 may optionally be used to reduce driver discomfort when the engine 21 is engaged to drive the wheels 3.

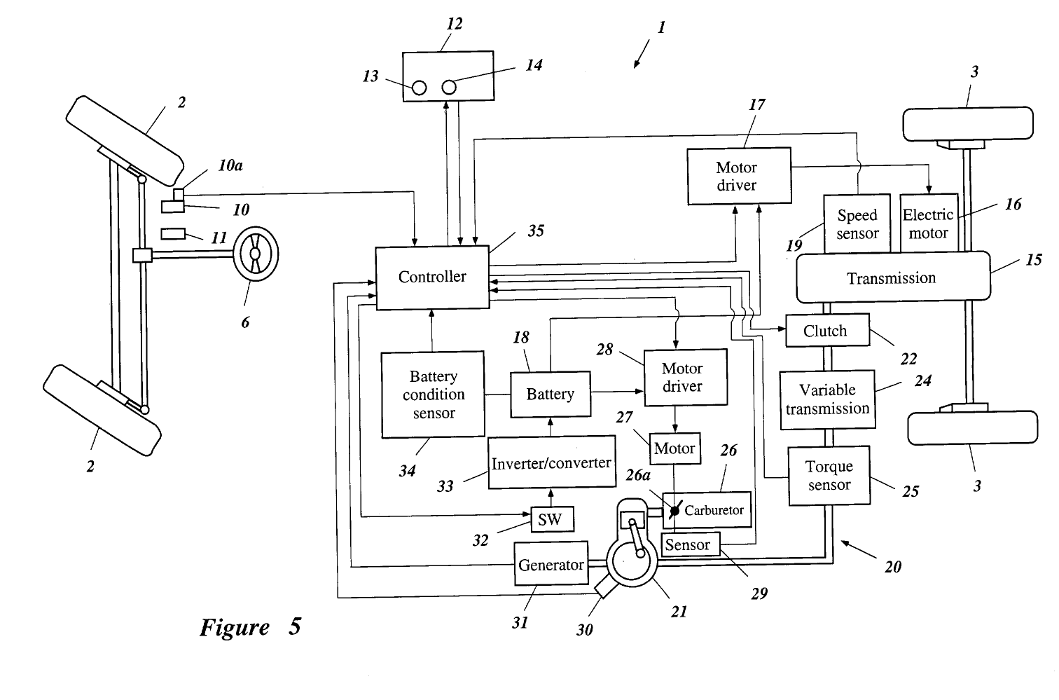

With reference to FIG. 5, a third embodiment of the present invention is illustrated therein. Components of the vehicle 1 that are similar to the corresponding components illustrated in FIGS. 2 and 4 are identified with the same reference numerals.

As illustrated in FIG. 5, a torque sensor 25 is disposed along the engine drive force transmission system 20 between the engine 21 and the transmission 15, preferably between the continuously variable transmission 24 and the engine 21. The variable transmission 24 is preferably a V-type continuously variable transmission. The sensor 25 is configured to detect the drive torque from the engine 21 and to communicate a torque signal corresponding to the detected drive torque to the controller 35. Both the sensor 25 and the transmission 24 are preferably located between the clutch 22 and the engine 21.

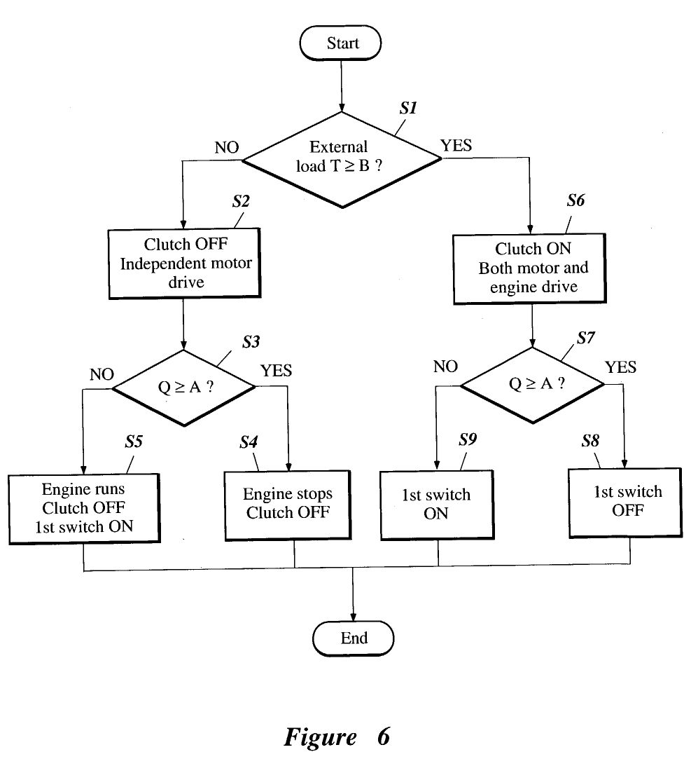

With reference to FIG. 6, the operation of the vehicle 1 according to the third embodiment is schematically illustrated therein. Specifically, the controller 35 calculates a load T corresponding to the throttle-command signal or the vehicle speed control signal. If the load T is lower than a predetermined reference value B (step S1), the controller 35 controls the operation of the motor 16 to drive the wheels 3 while the engine remains shut-off (step S2). The controller 35 also communicates an OFF signal to the clutch 22 to disengage the clutch 22 from the engine drive force transmission system 20. Accordingly, when the load T is lower than the predetermined value B, the vehicle 1 operates in the independent motor drive mode.

While the vehicle 1 operates in the independent motor drive mode, the controller 35 compares the residual capacity Q of the battery 18 that it receives from the sensor 34 with a reference capacity A (step S3). If the residual capacity Q is equal to or greater than the reference capacity A, the battery 18 is deemed to have sufficient charge. Accordingly, the controller 35 continues to communicate an OFF signal to the clutch 22 to maintain the clutch 22 disengaged from the transmission system 20 so that the engine 21 does not operate as a brake and resists against propulsion of the vehicle 1. Further, the engine 21 remains shut-off (step S4).

On the other hand, if the residual capacity Q is lower than the reference capacity A, the battery is deemed to have insufficient charge. Accordingly, the controller 35 continues to communicate an OFF signal to the clutch 22 to maintain the clutch disengaged from the transmission system 20. However, the controller 35 communicates a signal to the ignition system to start the engine 21.

Once the controller 35 registers start-up of the engine 21, the controller 35 communicates a control signal to the motor driver 28 corresponding to the difference between the battery capacity Q and the reference capacity A. The motor driver 28 drives the throttle motor 27 to adjust the position of the throttle valve 26a in response to the signal from the controller 35. The throttle motor 27 then adjusts the throttle valve 26a to a desired position so as to charge the battery 18 by an amount corresponding to the difference between the reference capacity A and the residual capacity Q. The carburetor 26 delivers a fuel charge to the engine 21 corresponding to the valve 26a position, and the engine 21 drives the generator 31 to generate electric power.

The controller 35 also communicates an ON signal to the switch 32 to allow transmission of the electric power produced by the generator 31 to the battery 18 (step S5). The inverter/converter 33 transforms the electric power output by the generator 31 to form usable by the battery 18. For example, if the generator 31 outputs electric power in the form of an alternating current, the inverter/converter 32 transforms it to a direct current before it is transmitted to the battery 18. Accordingly, charging of the battery 18 is achieved. If the capacity Q reaches a capacity value greater than the reference capacity A, the engine 21 is preferably shut-off through the ignition system to avoid overcharging the battery 18.

According to the present embodiment, if the controller 35 calculates a load T that is equal to or greater than the predetermined reference value B (step S1), the controller 35 controls the operation of the motor 16 and the engine 21 so that both the motor 16 and the engine 21 drive the wheels 3. Accordingly, the vehicle 1 operates in the hybrid drive mode. The controller 35 communicates a start-up signal to the ignition system. The ignition system actuates the starter motor to start the engine 21, and the fuel supply system starts up. The controller 35 also communicates an ON signal to the clutch 22 to engage the clutch 22 to the engine drive force transmission system 20. Therefore, the drive force produced by the engine 21 is transmitted to the wheels 3 (step S6).

As illustrated in FIG. 6, while the vehicle 1 operates in the hybrid drive mode, the controller 35 compares the residual capacity Q of the battery 18 that it receives from the sensor 34 with the reference capacity A (step S7). If the residual capacity Q is greater than the reference capacity A, the battery 18 is deemed to have sufficient charge. Accordingly, the controller 35 communicates an OFF signal to the switch 32 (step S8) to prohibit transmission of electric power from the generator 31 to the battery 18 to avoid overcharging the battery 18.

On the other hand, if the residual capacity Q is lower than the reference capacity A, the battery 18 is deemed to have insufficient charge. Accordingly, the controller 35 communicates an ON signal to the switch 32 (step S9) to allow transmission of the electric power generated by the generator 31 to the battery 18. Accordingly, charging of the battery 18 is achieved. If the capacity Q reaches a value greater than the reference capacity A, the switch 18 is preferably shut-off.

Therefore, according to the third embodiment of the present invention, the vehicle 1 operates so that the battery 18 is maintained in a condition of sufficient charge. Additionally, the continuously variable transmission 24 absorbs any impact caused by a rapid increase in drive torque from the engine 21 when the clutch 22 is engaged to the transmission system 20. Moreover, the variable transmission 24 compensates for any difference in drive torque between the engine 21 and motor 16 when the load increases abruptly. Accordingly, driver comfort is improved.

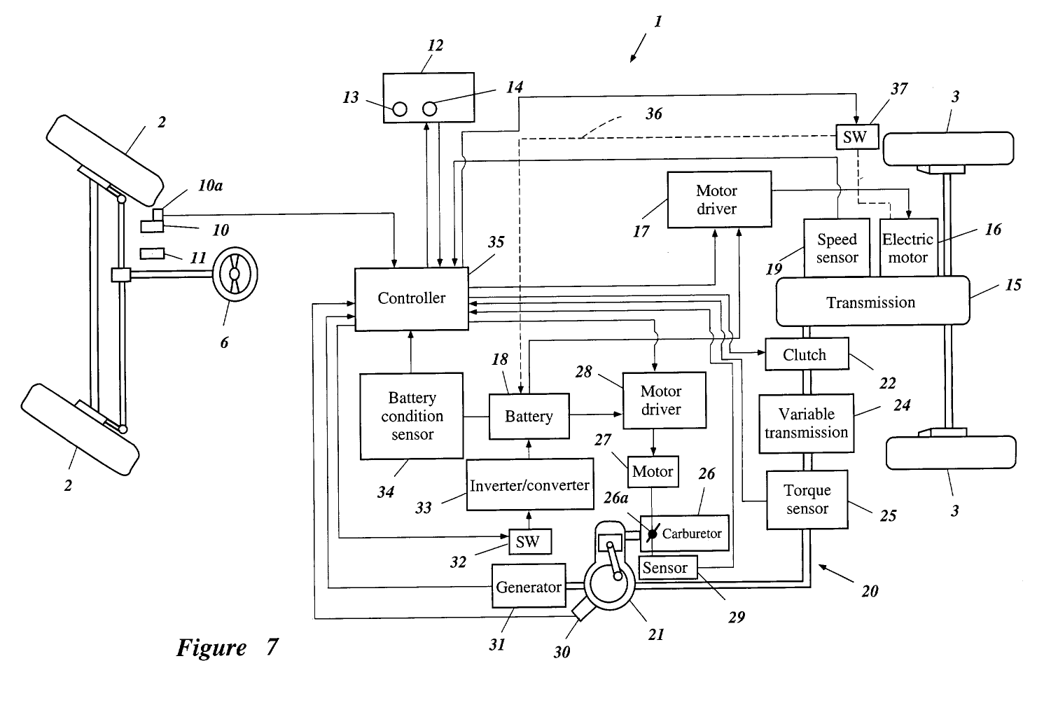

With reference to FIG. 7, a modification of the third embodiment is illustrated therein. Components of the vehicle 1 that are similar to the corresponding components illustrated in FIG. 5 are identified with the same reference numeral, whereas dissimilar components are identified with a prime symbol (e.g., “16′”).

As illustrated in FIG. 7, a motor-generator 16′ is disposed so as to rotate the input shaft of the transmission 15 that is connected to the drive wheels 3. The motor-generator 16′ is also connected to the motor driver 17 and is further configured to generate electric power. Further, an electric charge wire 36 connects the motor-generator 16′ to the battery 18. A second switch 37 is disposed along the wire 36 between motor-generator 16′ and the battery 18 and is configured to communicate with the controller 35.

According to this aspect of the present embodiment, if the controller 35 receives a residual battery capacity Q signal from the sensor 34 that is lower than the reference capacity A, the controller 35 selectively communicates an ON signal to the second switch 37 to allow transmission of electric power generated by the motor-generator 16′ through the wire 36 to the battery 18 when the motor-generator 16′ is functioning as a generator. Charging of the battery 18 is thus achieved under some operating conditions. For example, during a braking operation of the vehicle 1, electric power is generated by the inertia of the motor-generator 16′ while it slows down, which can be transmitted through the wire 36 to charge the battery 18. As a result, use of the motor-generator 16′ in combination with the engine 21 to charge the battery 18 decreases the amount of fuel consumed by the engine 21 to charge the battery 18, compared with the amount of fuel consumed when only the engine 21 is used to charge the battery 18.

If the residual capacity Q is equal to or greater than the reference capacity A, the controller 35 communicates an OFF signal to the second switch 37 to prohibit transmission of the electric power generated by the motor-generator 16′ to the battery 18. This avoids overcharging of the battery 18.

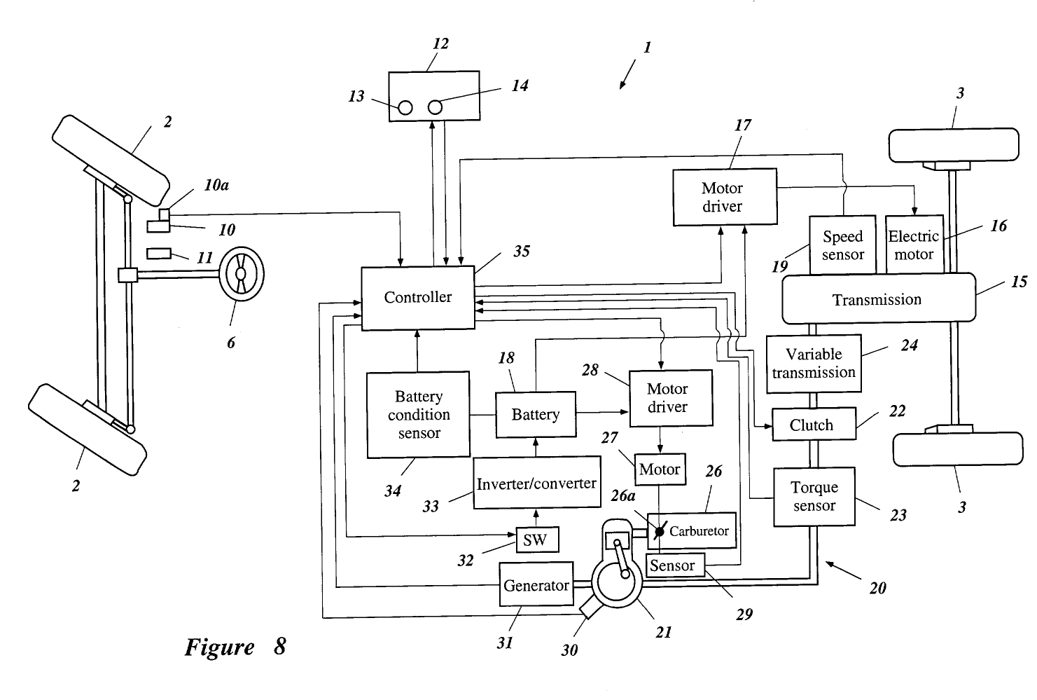

With reference to FIG. 8, a modification of the third embodiment is illustrated therein based on speed rather than load. Components of the vehicle 1 that are similar to the corresponding components illustrated in FIGS. 2 and 5 are identified with the same reference numeral, whereas dissimilar components are identified with a prime symbol (e.g., “32′”).

As illustrated in FIG. 8, a torque sensor 23 is disposed along the drive force transmission system 20 between the engine 21 and the transmission 15, preferably upstream of the continuously variable transmission 24 and the clutch 22. The variable transmission 24 is preferably a V-type continuously variable transmission that is preferably disposed between the clutch 22 and the transmission 15. The sensor 23 is configured to detect the drive torque from the engine 21.

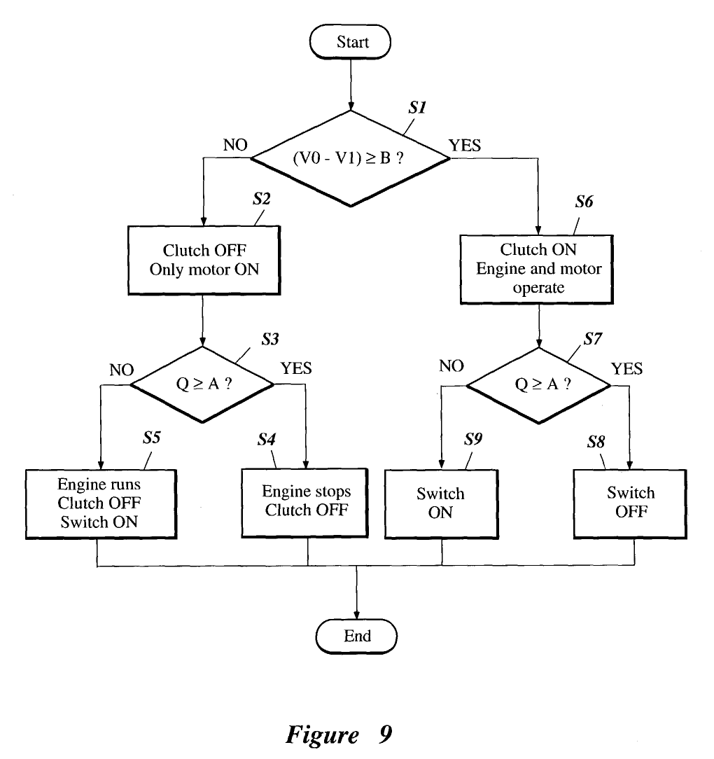

With reference to FIG. 9, the operation of the vehicle 1 according to the present embodiment is schematically illustrated therein. Specifically, during operation of the vehicle 1, the controller 35 receives a detected vehicle speed V1 of the vehicle 1 from the speed sensor 19. The controller 35 compares the detected vehicle speed V1 with a target vehicle speed V0 input by an input device. The input device may, for example, comprise a non-volatile memory. In another example, the input device may comprise a receiver. If the difference between the target vehicle speed V0 and the detected vehicle speed V1 is lower than a predetermined reference value B (step S1) the controller 35 controls the operation of the motor 16 to drive the wheels 3 while the engine 21 remains shut-off (step S2). The controller 35 also communicates an OFF signal to the clutch 22 to disengage the clutch 22 from the drive force transmission system 20. Accordingly, when the speed difference V0−V1 is lower than the predetermined value B, the vehicle 1 operates in the independent motor drive mode.

While the vehicle 1 operates in the independent motor drive mode, the controller 35 compares the residual capacity Q of the battery 18 that it receives from the sensor 34 with a reference capacity A (step S3). If the residual capacity Q is equal to or greater than the reference capacity A, the battery 18 is deemed to have sufficient charge. Accordingly, the controller 35 continues to communicate an OFF signal to the clutch 22 to maintain the clutch 22 disengaged from the transmission system 20 so that the engine 21 does not operate as a brake and resists against propulsion of the vehicle 1. Further, the engine 21 remains shut-off (step S4).

On the other hand, if the residual capacity Q is lower than the reference capacity A, the battery is deemed to have insufficient charge. Accordingly, the controller 35 continues to communicate an OFF signal to the clutch 22 to maintain the clutch 22 disengaged from the transmission system 20. However, the controller 35 communicates a signal to the ignition system to actuate the starter motor to start the engine 21.

Once the controller 35 registers start-up of the engine 21, the controller 35 communicates a control signal to the throttle motor driver 28 corresponding to the difference between the battery capacity Q and the reference capacity A. The motor driver 28 drives the throttle motor 26 to adjust the position of the throttle valve 26a in response to the signal from the controller 35. The throttle motor 26 then adjusts the throttle valve 26a to a desired position so as to charge the battery 18 by an amount corresponding to the difference between the reference capacity A and the residual capacity Q. The carburetor 26 delivers an air-fuel charge, including fuel from the fuel supply system, to the engine 21 corresponding to the valve 26a position, and the engine 21 drives the generator 31 to generate electric power.

The controller 35 also communicates an ON signal to the switch 32 to allow transmission of the electric power produced by the generator 31 to the battery 18 (step S5). The inverter/converter 33 transforms the electric power transmitted by the generator 31 to a form usable by the battery 18. For example, if the generator 31 transmits electric power in the form of an alternating current, the inverter/converter 33 transforms it to a direct current before it is transmitted to the battery 18. Accordingly, charging of the battery 18 is achieved.

Therefore, according to the independent electric motor drive mode of operation, if during operation of the vehicle 1 the difference between the target vehicle speed V0 and the detected vehicle speed V1 is below a reference value B, the controller 35 controls the operation of the motor 16 and the engine 21, so that only the motor 16 drives the wheels 3 to achieve the target speed V0. The controller 35 does this by disengaging the clutch 22. As long as the battery 18 is sufficiently charged, the engine 21 will remain shut-off and the clutch 22 disengaged, so that only the motor 16 drives the wheels 3. Accordingly, the fuel economy of the vehicle 1 is improved because the engine 21 is not used to charge the battery 18 in this situation, and noise corresponding to the operation of the engine 21 while charging the battery 18 is avoided. Therefore, the driving experience of the driver is improved.

If, however, the battery 18 capacity Q falls below a reference capacity A, the controller 35 controls the operation of the motor 16 and engine 21 so that the motor 16 continues to drive the wheels 3 while the engine 21 is started-up to drive the generator 31 to charge the battery 18. The detected speed V1 of the vehicle may drop some because the low battery capacity Q, when the battery 18 begins to be charged, may not be able to provide the motor 16 with sufficient power to maintain the detected speed V1. But the difference between the detected speed V1 and the target speed V0 should be small enough so that the driver does not detect a change in the driving performance of the vehicle 1 while the battery 18 is charged. Accordingly, the battery 18 can be charged while the vehicle 1 operates in the independent motor drive mode without significantly affecting the driving experience of the driver.

According to the present embodiment, if the controller 35 calculates a difference between the target vehicle speed V0 and the detected vehicle speed V1 that is equal to or greater than the predetermined reference value B (step S1), the controller 35 controls the operation of the motor 16 and the engine 21 so that both the motor 16 and the engine 21 drive the wheels 3 to achieve the target vehicle speed V0. Accordingly, the vehicle 1 operates in the hybrid drive mode. The ignition system actuates the starter motor to start the engine 21, the fuel supply system starts up, and the controller 35 communicates an ON signal to the clutch 22 to engage the clutch 22 to the drive force transmission system 20 (step 6). Therefore, the drive force produced by the engine 21 is transmitted to the wheels 3.

As illustrated in FIG. 9, while the vehicle 1 operates in the hybrid drive mode, the controller 35 compares the residual capacity Q of the battery 18 that it receives from the sensor 34 with the reference capacity A (step S7). If the residual capacity Q is greater than the reference capacity A, the battery 18 is deemed to have sufficient charge. Accordingly, the controller 35 communicates an OFF signal to the switch 18 (step S8) to avoid overcharging the battery 18.

On the other hand, if the residual capacity Q is lower than the reference capacity A, the battery 18 is deemed to have insufficient charge. Accordingly, the controller 35 communicates an ON signal to the switch 18 (step S9) to allow transmission of the electric power generated by the generator 31 to the battery 18. Accordingly, charging of the battery 18 is achieved.

Therefore, if during operation of the vehicle 1 in the hybrid drive mode the difference between the target speed V0 and the detected speed V1 is equal to or greater than the reference value B, the controller 35 controls the operation of the motor 16 and the engine 21, so that both the motor 16 and the engine 21 drive the wheels 3 to achieve the target speed V0. The controller 35 does this by engaging the clutch 22. The controller 35 uses both the motor 16 and engine 21 to drive the wheels 3 because the difference between the target speed V0 and the detected speed V1 is sufficiently large that the drive force from both the motor 16 and the engine 21 is required to achieve the target speed V0 without the driver experiencing a change in the driving experience of the vehicle 1. Moreover, as long as the battery 18 is sufficiently charged, the controller 35 prohibits transmission of electric power generated by the generator 31 from the generator 31 to the battery 18 by communicating an OFF signal to the switch 32.

If, however, the battery 18 capacity Q falls below a reference capacity A, the controller 35 will control the operation of the motor 16 and engine 21 so that both the motor 16 and the engine 21 continue to drive the wheels 3 while the engine 21 also transmits a drive force to the generator 31 to generate electric power to charge the battery 18. The detected speed V1 of the vehicle may drop some because some of the drive force generated by the engine 21 will be used to charge the battery 18 through the electric power generated by the generator 31. Therefore, the amount of drive force transmitted from the engine 21 to the wheels 3 through the drive force transmission system 20 will be lower than if the engine 21 did not transmit drive force to the generator 31 to charge the battery 18. However, the amount of drive force transmitted from the engine 21 to the generator 31 may be small enough to not significantly alter the acceleration characteristics of the vehicle 1, so that the driver does not detect a change in driving performance while the battery 18 is charged. Accordingly, the battery 18 can be charged while the vehicle 1 operates in the hybrid drive mode without significantly affecting the driving experience of the driver.

Therefore, according to the present embodiment, the vehicle 1 operates so that the battery 18 is maintained in a condition of sufficient charge while the vehicle 1 accelerates to reach a desired target vehicle speed V0. Additionally, the continuously variable transmission 24 absorbs any impact caused by a rapid increase in drive torque from the engine 21 when the clutch 22 is engaged to the transmission system 20. Moreover, the variable transmission 24 compensates for any difference in drive torque between the engine 21 and motor 16 when the load increases abruptly. Accordingly, driver comfort is improved.

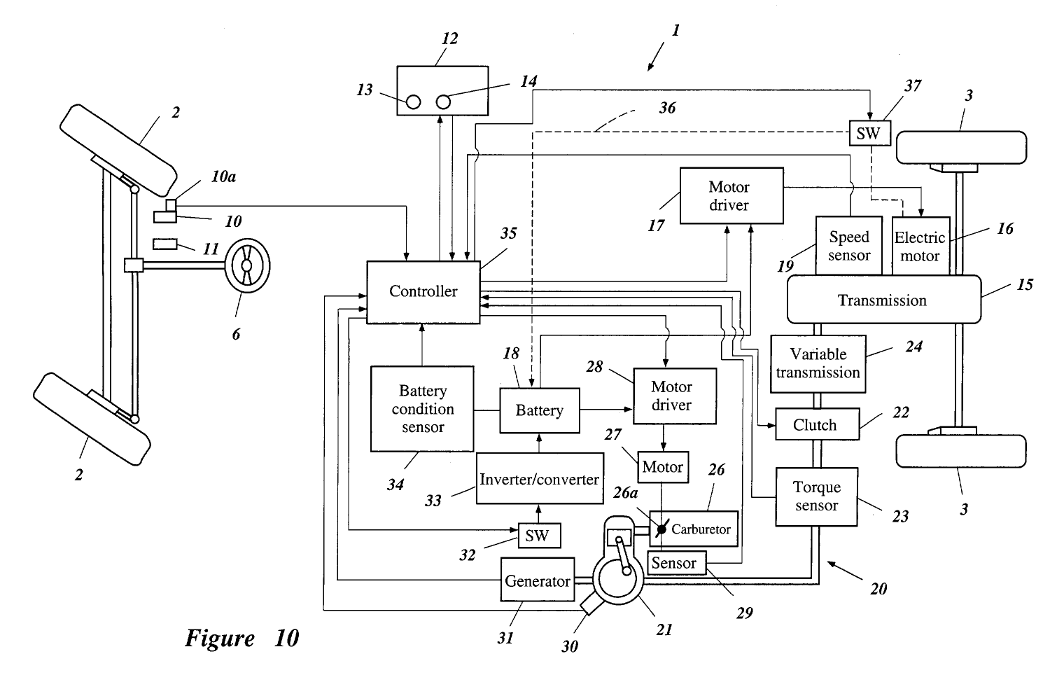

With reference to FIG. 10, a modification of the third embodiment is illustrated therein. Components of the vehicle 1 that are similar to the corresponding components illustrated in FIGS. 5 and 7 are identified with the same reference numeral, whereas dissimilar components are identified with a prime symbol (e.g., “32′”).

As illustrated in FIG. 10, a motor-generator 16′ is disposed so as to rotate the input shaft of the transmission 15 that is connected to the drive wheels 3. The motor-generator 16′ is also connected to the motor driver 17 and further configured to generate electric power. An electric charge wire 36 connects the motor-generator 16′ to the battery 18. A second switch 37 is disposed along the wire 36 between motor-generator 16′ and the battery 18 and is configured to communicate with the controller 35.

According to this aspect of the present embodiment, during operation of the vehicle in a hybrid drive mode, if the controller 35 receives a residual battery capacity Q signal from the sensor 34 that is lower than the reference capacity A while the detected vehicle speed V1 is greater than the target vehicle speed V0, the controller 35 communicates an ON signal to the second switch 37. Electric power generated by the motor-generator 16′ is then transmitted through the wire 36 to battery 18 to charge the battery 18. The controller 35 also communicates an OFF signal to the clutch 22 to disengage the clutch 22 from the transmission system 20. The controller 35 also communicates an OFF signal to the switch 32 to prohibit transmission of electric power from the generator 31 to the battery 18.

Further, the controller 35 communicates a control signal to the throttle motor driver 28 to adjust the throttle-valve 26a position in the carburetor 26 to a minimum position. The throttle motor driver 28 drives the throttle motor 27 to adjust the throttle-valve 26a position according to the control signal from the controller 35. The throttle motor 27 adjusts the position of the throttle valve 26a to a minimum position and the carburetor 26 delivers a fuel charge to the engine 21 corresponding to said minimum throttle-valve 26a position. Accordingly, electric power generated by the motor-generator 16′ is used to charge the battery 18 while the engine 21 is controlled to produce minimum power and is prohibited from transmitting a drive force to the wheels 3 through the engine drive force transmission system 20 by disengaging the clutch 22 from the transmission system 20.

For example, during a braking operation of the vehicle 1, electric power is generated while the motor-generator 16′ slows down, which can be transmitted through the wire 36 to charge the battery 18. Additionally, while the vehicle is in a coasting mode, neither the motor-generator 16′ nor the engine 21 drives the wheels 3. Instead, a drive force is transmitted from the wheels 3 through the transmission 15 to the motor-generator 16′. Accordingly, the motor-generator 16′ is back driven, allowing the motor-generator 16′ to generate electric power, which is transmitted to the battery 18 through wire 36 to charge the battery.

If the residual capacity Q is equal to or greater than the reference capacity A while the vehicle operates in the hybrid drive mode and while the detected vehicle speed V1 is greater than the target vehicle speed V0, the controller 35 communicates an OFF signal to the switches 18, 31, which prevents transmission of the electric power generated by the motor-generator 16′ or the generator 31 to the battery 18, respectively. Further, the controller communicates an ON signal to the clutch 22 to engage with the engine drive force transmission system 20. The controller 35 also communicates a control signal to the motor driver 28 to adjust the position of the throttle valve 26a to a minimum position so that the engine 21 is controlled to produce minimum power as described above.

Accordingly, when the vehicle 1 travels at a detected speed V1 that is greater than the target vehicle speed V0, and the battery 18 is sufficiently charged above a reference capacity A, the vehicle 1 can be slowed down by decreasing the power output of the engine 21. Moreover, drive force created by the slowdown of the wheels 3 can be transmitted to the engine 21 through the transmission system 20 and to the motor-generator 16′ through the motor drive force transmission system for braking purposes. However, any electric power generated by the motor-generator 16′ or by the generator 31, through the engine 21, is not transmitted to the battery 18 to charge the battery 18. Therefore, according to this modification of the present embodiment, the battery 18 can be maintained in sufficient charge and not be overcharged while the vehicle 1 is slowed down to achieve a target vehicle speed V0.

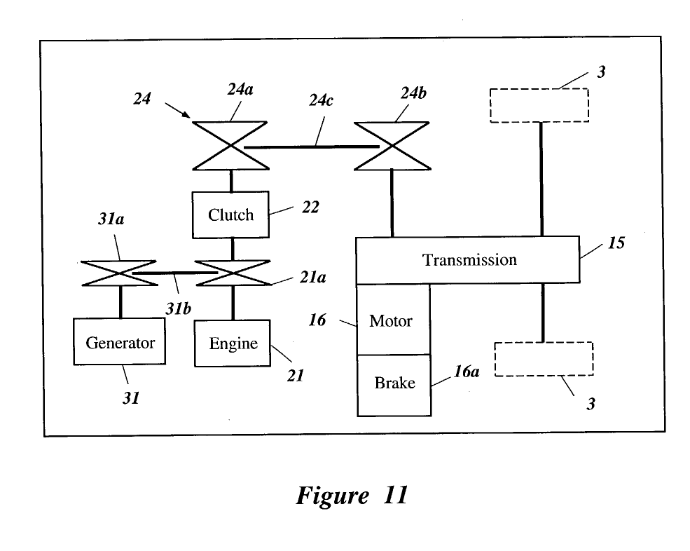

With reference to FIG. 11, the drive force transmission system 20 in the present embodiment is further illustrated therein. The engine 21 connects to the generator 31 through a pulley system comprising a drive pulley 21a connected to the crankshaft of the engine 21, a driven pulley 31a connected to an input shaft of the generator 31, and a belt 31b wrapped around the drive pulley 21a and the driven pulley 31a. The belt 31b may alternatively be a chain, gears, or similar transmitter.

As illustrated in FIG. 11, the variable transmission 24 comprises a drive pulley 24a connected to the crankshaft of the engine 21 through the clutch 22. The clutch 22 is preferably an electromagnetic clutch. The variable transmission 24 also comprises a driven pulley 24b connected to the input shaft of the transmission 15 and a V-belt 24c that wraps around the pulleys 24a, 24b.

The transmission 15, as illustrated in FIG. 11, connects to the electric motor 16. The motor may optionally be connected to an electromagnetic brake 16a disposed in the motor 16.

While the engine 21 operates at idle speed, the variable transmission 24 does not transmit any torque from the engine 21 to the transmission 15 through the transmission system 20. However, when the engine 21 operates at a speed greater than idle speed, the variable transmission 24 does transmit the drive torque generated by the engine 21 of the wheels 3, through the transmission system 20. Moreover, the lower the speed of the engine 21 is, the greater the reduction ratio of the variable transmission 24. As described above, when the difference between the target vehicle speed V0 and the detected vehicle speed V1 is less than a predetermined value B, if the residual capacity Q of the battery 18 is greater than a reference capacity A, the engine 21 is stopped and the clutch 22 is disengaged from the transmission system 20 so that the drive force from the engine 21 is not transmitted to the drive wheels 3 However, if the battery capacity Q of the battery 18 falls below the reference capacity A, the controller 35 starts the engine 21 through the ignition system while maintaining the clutch 22 disengaged from the transmission system 20. Accordingly, only the motor 16 drives the wheels 3 and the engine 21 does not interfere with the propulsion of the vehicle 1.

Further, if the difference between the target vehicle speed V0 and the detected vehicle speed V1 is greater than a reference value B, the controller 35 controls the operation of the motor 16 and engine 21 so that both the motor 16 and the engine 21 drive the wheels 3. Additionally, the controller 35 communicates an ON signal to the clutch 22 to engage the clutch 22 to the transmission system 20 to allow transmission of the drive force from the engine 21 to be transmitted to the drive wheels 3.

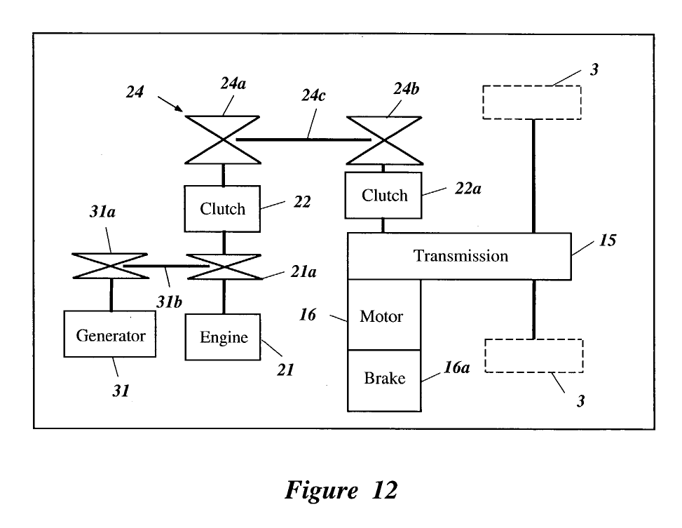

FIG. 12 illustrates a modification to the engine drive force transmission system 20 illustrated in FIG. 11. According to the transmission system 20 of FIG. 12, a second clutch 22a is disposed along the transmission system 20, preferably between the driven pulley 24b of the variable transmission 24 and the transmission 15. The second clutch 22a is preferably an electromagnetic clutch that is configured to communicate with the controller 35.

As discussed above regarding the operation of the transmission system 20 illustrated in FIG. 11, when the difference between the target vehicle speed V0 and the detected vehicle speed V1 is lower than a predetermined value B, if the battery capacity Q of the battery 18 is equal to or greater than the reference capacity A, the engine 21 remains shut-off Moreover, according to the transmission system 20 illustrated in FIG. 12, the controller 35 communicates an OFF signal to the second clutch 22a to disengage the second clutch 22a from the transmission system 20. Optionally, the controller 35 also communicates an OFF signal to the clutch 22 to disengage the clutch 22 from the transmission system 20. Accordingly, the transmission of drive force between the engine 21 and the transmission 15 is prevented.

If, on the other hand, the battery capacity Q is lower than the reference capacity A, the controller 35 starts the engine 21 via the ignition system, but communicates an OFF signal to the clutches 22, 22a to disconnect the clutches 22, 22a from the transmission system 20. Accordingly, none of the drive force generated by the engine 21 is transmitted to the wheels 3. Instead, all of the drive force generated by the engine 21 is transmitted to the generator 31 to generate electric power to charge the battery 18.

Additionally, if the difference between the target vehicle speed V0 and the detected vehicle speed V1 is greater than the predetermined value B, the controller 35 starts up the engine 21 via the ignition system and communicates an ON signal to the clutches 22, 22a to engage both clutches 22, 22a to the transmission system 20.

Accordingly, the second clutch 22a can be used to selectively prohibit the transmission of drive force from the engine 21 to the wheels 3. Moreover, the clutches 22, 22a can be used together to isolate the variable transmission 24 from a drive force transmitted from the engine 21 or from the wheels 3.

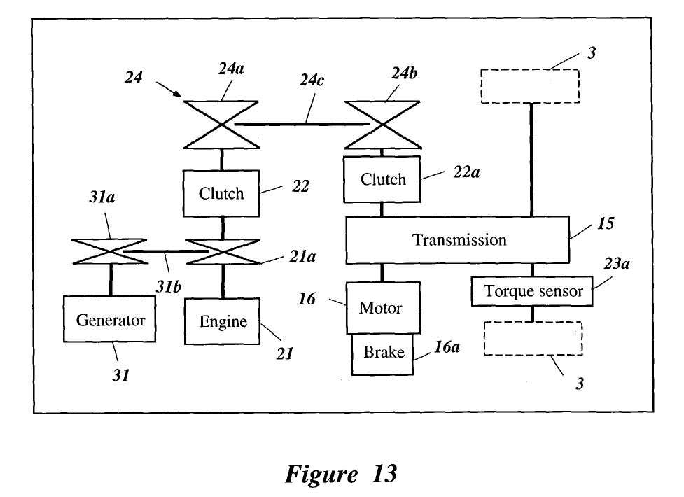

FIG. 13 illustrates a modification to the engine drive force transmission system 20 illustrated in FIG. 11. According to the modification in FIG. 13, a second clutch 22b is disposed between the driven pulley 24b of the variable transmission 24 and the transmission 15. The second clutch 22b is preferably a one-way clutch, configured to allow transmission of the drive force from the engine 21 to the wheels 3 through the transmission system 20 and to prevent the transmission of the drive force from the wheels 3 to the engine 21. Accordingly, the controller 35 does not need to control the second clutch 22b to prevent the transmission of drive force from the wheels 3 to the engine 21. However, the controller 35 cannot control the operation of the second clutch 22b to prevent the transmission of drive force from the engine 21 to the drive wheels 3. Instead, the controller 35 communicates an OFF signal to the clutch 22 to prevent transmission of the drive force generated by the engine 21 to the wheels 3.

The torque sensor 23, which is configured to detect the drive torque generated by the engine 21, may be disposed anywhere it can detect the drive torque generated by the engine 21. For example, the sensor 23 may be disposed between the engine 21 and the clutch 22, as illustrated in FIG. 10. Alternatively, the sensor 23a may be disposed along the rear axle connecting the drive wheels 3, as shown in FIG. 13.

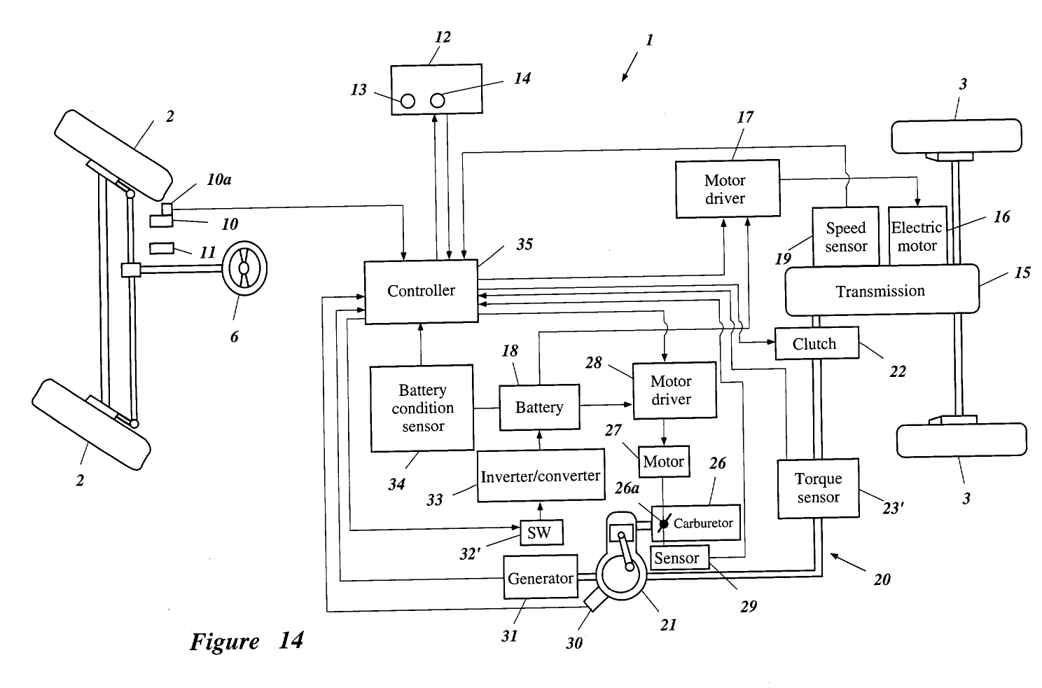

With reference to FIG. 14, a fourth embodiment of the present invention is disclosed therein. Components of the vehicle 1 that are similar to the corresponding components illustrated in FIG. 2 are identified with the same reference numeral, whereas dissimilar components are identified with a prime symbol (e.g., “23′”.

According to the fourth embodiment, a drive force sensor, which in the illustrated embodiment is a torque sensor 23′, is disposed along the engine drive force transmission system 20, preferably between the clutch 22 and the engine 21. The sensor 23′ is configured to detect the drive torque transmitted by the engine 21 to the drive wheels 3 and to communicate a torque signal corresponding to the detected drive torque to the controller 35. Additionally, a switch 32′ is disposed so as to communicate with the generator 31 and the inverter/converter 33. The switch 32′ is configured to selectively allow transmission of the electric power generated by the generator 31 to the battery 18.

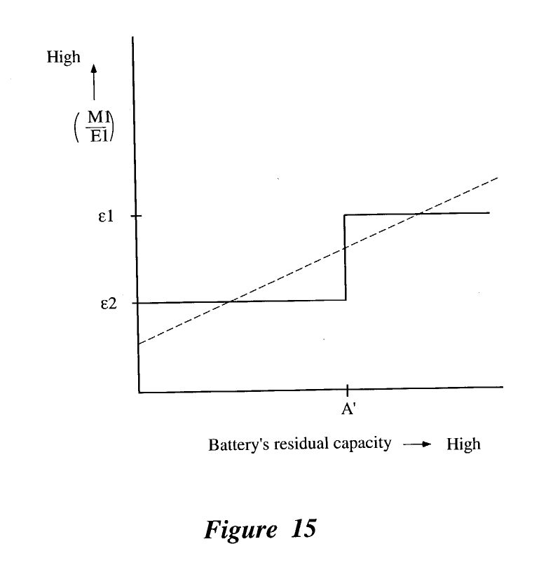

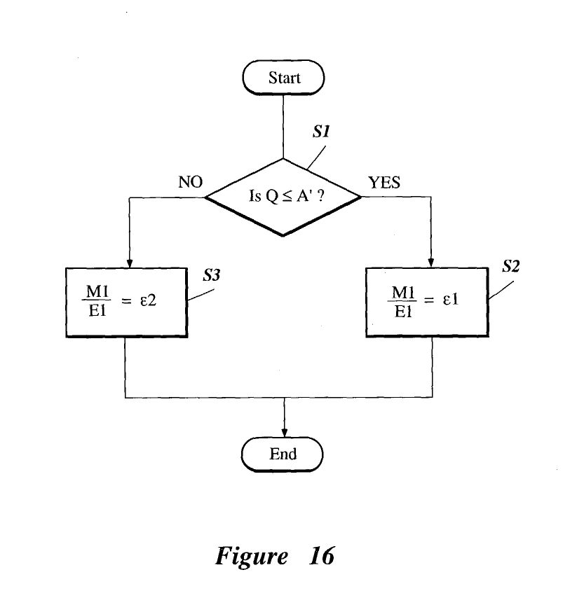

With reference to FIGS. 15 and 16, during operation of the vehicle 1 in the hybrid drive mode, the sensor 34 communicates a signal corresponding to the residual capacity Q of the battery 18 to the controller 35. The controller 35 compares the residual capacity Q with a second reference capacity A′ (step S1), where the second reference capacity A′ may be equal to the reference capacity A. If the residual capacity Q of the battery 18 is equal to or greater than the second reference capacity A′, the controller 35 communicates control signals to the motor drivers 17, 28 to regulate the operation of the motor 16 and engine 21, respectively, such that the ratio of the drive force M1 from the motor 16 to the drive wheels 3 relative to the drive force E1 from the engine 21 to the wheels 3 (i.e., M1/E1) equals a preset value ε1 (step S2). Similarly, if the residual capacity Q is lower than the second reference capacity A′, the controller 35 communicates control signals to the motor drivers 17, 28 to regulate the operation of the motor 16 and the engine 21, respectively, such that the ratio M1/E1 equals a preset value ε2 (step S3), where ε2 is preferably lower than ε1.

The motor driver 17 regulates the operation of the motor 16 by regulating the power supplied from the battery 18 to the motor 16. The motor 16 then generates a corresponding drive force M1 and transmits it to the drive wheels 3 through the motor drive force transmission system. Likewise, the throttle motor driver 28 regulates the operation of the engine 21 by adjusting the position of the throttle valve 26a on the carburetor 26 through the throttle motor 27. The carburetor 26 then delivers a fuel charge, including an amount of fuel from the fuel supply system, to the engine 21 corresponding to the throttle valve 26a position. The engine 21 generates a corresponding drive force E1 and transmits it to the drive wheels 3 through the engine drive force transmission system 20.

Furthermore, as the residual capacity Q of the battery 18 decreases, the controller 35 controls the operation of the motor 16 and engine 21 so that the drive force ratio M1/E1 decreases. For example, when the residual capacity Q of the battery 18 decreases below a minimum battery capacity setpoint for battery power transmission, the controller 35 communicates a control signal to the motor driver 17 to regulate the operation of the motor 16 such that the drive force ratio M1/E1 preferably is made equal to zero. That is, the controller 35 shuts off power supply to the motor 16 so that there is no transmission of drive force from the motor 16 to the drive wheels 3. Accordingly, the battery 18 is protected while the drive force from the engine 21 continues to drive the wheels 3.

Optionally, the controller 35 may control the operation of the motor 16 and the engine 21 such that the drive force ratio M1/E1 attains many preset values and is not limited only to two values, ε1 and ε2. The controller 35 may also control the operation of the motor 16 and the engine 21 such that the drive force ratio M1/E1 gradually increases with the increase in residual capacity Q, as illustrated by the dashed line in FIG. 15.

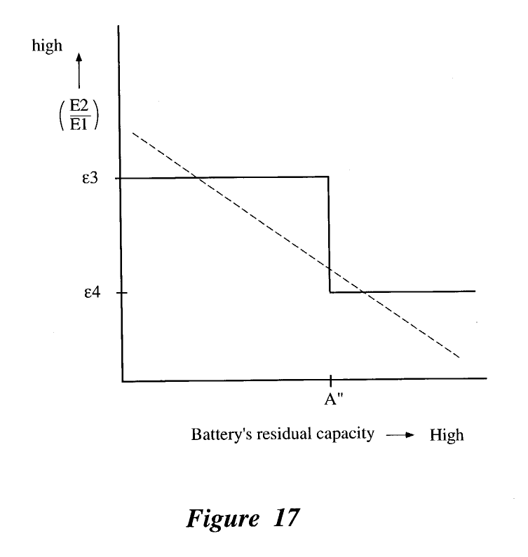

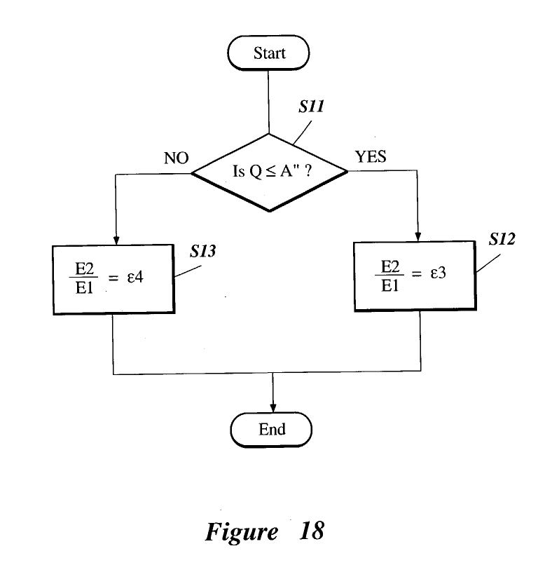

With reference to FIGS. 17 and 18, during operation of the vehicle 1 in the hybrid drive mode, the controller 35 also compares the residual capacity Q of the battery 18 to a third reference capacity A″ (step S11). The third reference capacity A″ may be equal to the reference capacity A or the second reference capacity A′. If the residual capacity Q is equal to or lower than the third reference capacity A″, the controller 35 controls the operation of the motor driver 28 and the switch 32′ such that the ratio of the drive force E2 from the engine 21 to the generator 31 relative to the drive force E1 from the engine 21 to the drive wheels 3 equals a preset value ε3 (step 12). Similarly, if the residual capacity Q is greater than the third reference capacity A″, the controller 35 controls the operation of the motor driver 28 and the switch 32′ such that the drive force ratio E2/E1 equals a preset value ε4, where ε4 is preferably lower than ε3 (step 13).

During operation of the vehicle 1 in the hybrid drive mode, both the motor 16 and the engine 21 drive the drive wheels 3 in response to a load on the vehicle 1. The engine 21 transmits a drive force E1 to the wheels 3 through the engine drive force transmission system 20 corresponding to a particular crankshaft speed.

If the residual capacity Q is equal to or lower than the third reference capacity A″, the controller 35 communicates a control signal to the motor driver 28 corresponding to the difference between the residual capacity Q of the battery 18 and the third reference capacity A″ to increase the power generated by the engine 21. The driver 28 drives the throttle motor 27 to adjust the throttle valve 26a on the carburetor 26 to a position corresponding to the control signal from the controller 35. The carburetor 26 delivers an increased fuel charge to the engine 21 corresponding to the adjusted throttle valve 26a position and the engine generates an increased drive force.

An increased portion of the drive force generated by the engine 21 is a drive force E2 transmitted to the generator 31 to generate electric power to charge the battery 18. The increased amount of the drive force is used to drive the generator without mutually changing the propulsion of the vehicle. The generator 31 generates electric power through the rotation of the crankshaft in the engine 21. The controller 35 communicates an ON signal to the switch 32′ to allow transmission of electric power from the generator 31 to the battery 18.

The remaining portion of the drive force generated by the engine 21 is a drive force E1 transmitted to the wheels 3 through the engine drive force transmission system. The drive force E1 does not vary, even though the drive force E2 is directed from the engine 21 to the generator 31, because the engine 21 operates at an increased crankshaft speed due to the increased fuel charge. Accordingly, the engine 21 provides a drive force E1 to help propel the vehicle 1 while providing a drive force E2 to charge the battery 18. The controller 35 controls the motor driver 28 and the switch 32′ such that the ratio of these drive forces E2/E1 equals ε3. If the residual capacity Q is greater than the third reference capacity A″, the controller 35 controls the motor driver 28 and the switch 32′ in a similar manner so that the ratio of the drive forces E2/E1 equals ε4.

The third reference capacity A″ corresponds, for example, to a percentage of the battery capacity of a fully charged battery 18. Preferably, the third reference value A″ corresponds approximately to 50% to 80% of the battery capacity of the fully charged battery 18.

Furthermore, according to the present embodiment, as the residual capacity Q of the battery 18 increases, the controller 35 controls the operation of the throttle motor driver 28 and the switch 32′ so that the drive force ratio E2/E1 decreases. For example, when the battery 18 is fully charged, the controller 35 controls the operation of the throttle motor driver 28 and the switch 32′ such that the drive force ratio E2/E1 preferably is made equal to zero. That is, the controller 35 communicates an OFF signal to the switch 32′ to shut off transmission of electric power from the generator 31 to the battery 18.

Optionally, the controller 35 may control the operation of the motor driver 28 and the switch 32′ such that the drive force ratio E2/E1 attains many preset values, so that the drive force ratio E2/E1 is not limited only to two values, ε3 and ε4. The controller 35 may also control the operation of the throttle motor driver 28 and the switch 32′ such that the drive force ratio E2/E1 gradually decreases with the increase in residual capacity Q, as illustrated by the dashed line in FIG. 17.

According to the present embodiment, the drive force ratio E2/E1 varies in relation to the period of operation of the switch 32′. For example, the longer the switch 32′ is in an ON position the greater the ratio E2/E1 becomes. However, the magnitude of the drive force E1 from the engine 21 to the wheels 3 does not vary. Instead, the longer the switch 32′ is ON, the greater the amount of drive force E2 is directed from the engine 21 to the generator 31 to generate electric power to charge the battery 18. Therefore, the ratio E2/E1 of the drive force from the engine 21 to the generator 31 to charge the battery 18 relative to the drive force from the generator 31 to the drive wheels 3 increases.

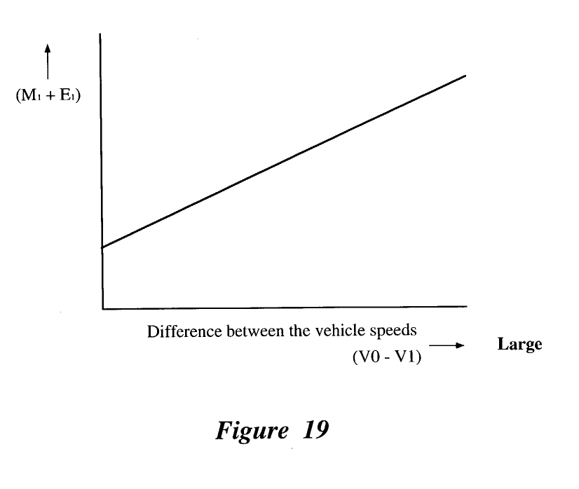

Additionally, while the vehicle 1 operates in the automatic travel mode, the controller 35 receives a vehicle speed signal from the vehicle speed sensor 19 corresponding to the detected vehicle speed V1. The controller 35 compares the vehicle speed V1 with the target vehicle speed V0. In the present embodiment, if the difference between detected vehicle speed V1 and the target vehicle speed V0 increases, the controller 35 communicates control signals to the motor drivers 17, 28 to operate the motor 16 and the engine 21 such that the sum (M1+E1) of the drive force E1 from the motor 16 and the drive force M1 from the engine 21 gradually increases, as illustrated in FIG. 19.

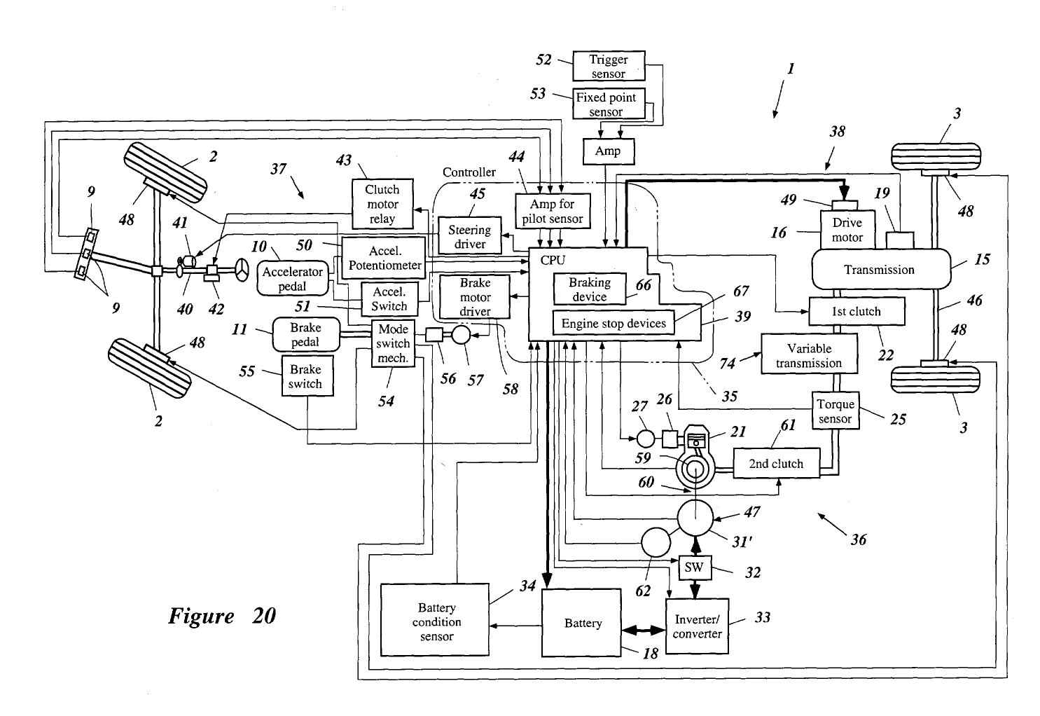

With reference to FIG. 20, a fifth embodiment of the hybrid vehicle 1 is illustrated therein. Components of the vehicle 1 that are similar to the corresponding components illustrated in FIGS. 2 and 4 are identified with the same reference numerals, whereas dissimilar components are identified with a prime symbol (e.g., “31′”).

The vehicle 1 comprises a traveling device 36, which in turn comprises an automatic steering device 37, a driving device 38, and the controller 35 having a central processing unit (hereafter referred to as the CPU) 39.

The automatic steering device 37 comprises the pilot wire detection sensor 9 configured to communicate with the CPU 39 and connected to the front axle connecting the front wheels 2. A steering shaft 40 connects the steering wheel 6 to a steering motor 41 disposed rearwardly of the front wheels 2 and connected to the front wheels 2 by a steering linkage assembly. A steering clutch 42 is disposed along the steering shaft 40, preferably between the steering wheel 6 and the steering motor 41. The steering clutch 42 is configured to communicate with the CPU 39 through a clutch motor relay 43 disposed between the controller 35 and the clutch 42.

A pilot signal amplifier 44 is disposed in the controller 35 and is configured to communicate with the CPU 39 and the pilot wire detection sensor 9. A steering driver 45 is also disposed in the controller 35 and configured to communicate with the CPU 39 and the steering motor 41.

The driving device 38 comprises a rear axle 46 disposed between the rear wheels 3 and connected to the transmission 15. The transmission 15 is connected to the drive motor 16, which is configured to communicate with the CPU 39. The battery 18 is configured to communicate with the drive motor 16 to supply electric power to the motor 16. The driving device 38 further comprises an auxiliary engine generating system 47 connected to the transmission 15 and the battery 18, and brakes 48 disposed adjacent to the wheels 2, 3. The brakes 48 are preferably drum brakes and configured to transmit a braking force to the wheels 2, 3. According to the present embodiment, a brake 49, preferably configured to operate as a parking brake, is also disposed in the drive motor 16. The brake 49 is preferably an electromagnetic brake.

The CPU 39 is configured to communicate with the accelerator pedal 10 disposed substantially forward in the vehicle 1 through an accelerator potentiometer 50 and an accelerator switch 51, where the potentiometer 50 and the switch 51 are preferably disposed substantially parallel to each other. The CPU 39 is also configured to communicate with the vehicle speed sensor 19. A trigger sensor 52 and a fixed-point sensor 53 are configured to detect a permanent marking on a road (not shown) and to communicate with the CPU 39. The trigger sensor 52 is also preferably disposed on the chassis 4.

The brake pedal 11 is configured to communicate with a mode switching mechanism 54. The mode switching mechanism 54 connects to the brakes 48 through a brake cable. A brake switch 55 disposed next to the pedal 11 is configured to operate in association with the pedal 11 and to communicate with the CPU 39. A gear mechanism 56 connects the mode switching mechanism 54 to a brake motor 57. The brake motor 57 in turn communicates with a brake motor driver 58 that is disposed in the controller 35, where the driver 58 is configured to communicate with the CPU 39.

The auxiliary engine generating system 47 comprises the engine 21 having the crankshaft 59, the ignition system (not shown) and the fuel supply system (not shown). A transmission device 60, which is preferably a V-belt type transmission device, connects the crankshaft 59 to the motor-generator 31′. Further, the continuously variable transmission 24, which is preferably a V-belt type continuously variable transmission, is disposed between the clutch 22 (herein after referred to as the first clutch) and a second clutch 61, wherein both clutches 22, 61 are disposed between the engine 21 and the transmission 15 and are configured to communicate with the CPU 39.

According to the present embodiment, the throttle motor 27 is configured to communicate with the CPU 39. An engine speed sensor 62 connects to the motor-generator 31′, and is configured to detect the speed of the engine 21 and to communicate with the CPU 39. Additionally, a start switch 32 is disposed between the motor-generator 31′ and the inverter/converter 33. The start switch 32 is configured to allow transmission of electric power between the motor-generator 31′ and the battery 18. The inverter/converter is configured to transform the electric power transmitted between the motor-generator 31 and the battery 18 from a form usable by the battery 18 to a form usable by the motor-generator 31.

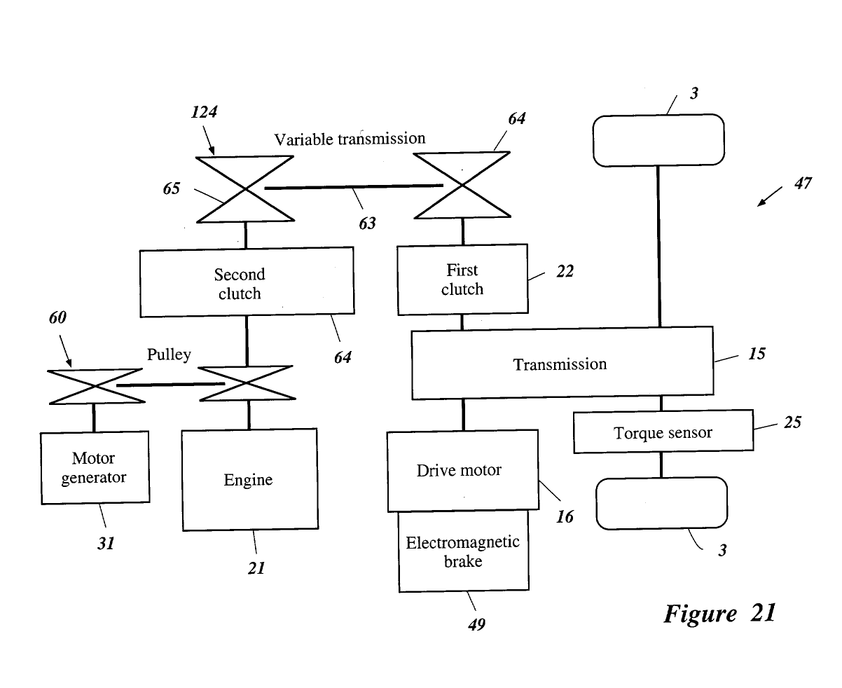

As illustrated in FIG. 21, the variable transmission 24 comprises a V-belt 63 connected to a driven pulley 64 and a drive pulley 65. The driven pulley 64 connects to the input shaft of the transmission 15 through the first clutch 22. Similarly, the drive pulley 65 connects to the crankshaft 59 of the engine 21 through the second clutch 61.

The torque sensor 25, which is configured to detect the drive torque generated by the engine 21, may be disposed anywhere it can detect the drive torque generated by the engine 21. For example, the sensor 25 may optionally be disposed between the second clutch 61 and the variable transmission 24 as illustrated in FIG. 20. Alternatively, the sensor 25 may be disposed along the rear axle 46 as shown in FIG. 21.

The battery residual capacity detecting sensor 34 is configured to detect the residual capacity of the battery 18, to generate a signal corresponding to said battery capacity, and to communicate said signal to the CPU 39. The detecting sensor 34 may be for example a battery condition sensor or any other mechanism capable of gauging the capacity of the battery 18. The CPU 39 also comprises a braking device 66 and an engine stop device 67. The braking device 66, for example, may be a braking operation controller. Likewise, the engine stop device 67, for example, may be an engine operation controller.

In the manual travel mode, the driver steers the vehicle 1 by rotating the steering wheel 6, which rotates the steering shaft 40 a corresponding amount. Consequently, the shaft 40 drives the steering motor 41 to rotate the front wheels 2 an amount and in a direction corresponding to the rotation of the shaft 40. For example, if the steering wheel 6 is rotated clockwise, the steering motor 41 rotates the front wheels 2 clockwise a corresponding amount, as viewed from a top view of the vehicle 1.

In the automatic travel mode, the CPU 39 communicates a signal to the clutch motor relay 43, which then drives the steering clutch 42 to disconnect the steering wheel 6 from the steering shaft 40. Subsequently, the CPU 39 communicates a steering control signal to the steering driver 45 corresponding to a pilot wire signal the CPU 39 receives from the pilot wire detection sensor 9 through the pilot signal amplifier 44. The steering driver 45 then drives the steering motor 41 to rotate the front wheels 2 in the amount and direction required for the vehicle 1 to follow the pilot wire (not shown).

In the manual travel mode, the driver propels the vehicle 1 by pressing the accelerator pedal 10. The driver may press the pedal 10, when the external load on the vehicle 1 increases, for example during uphill travel, or if the driver intends to accelerate the vehicle 1. The pedal 10 communicates a pedal displacement signal to the CPU 39 through the accelerator potentiometer 50 and the accelerator switch 51. The battery 18 supplies a driving current to the CPU 39. The CPU 39 then regulates the driving current it supplies to the drive motor 16 to correspond to the displacement of the acceleration pedal 10. The motor 16 generates a drive force corresponding to the driving current provided by the CPU 39 and transmits the drive force to the drive wheels 3 through the transmission 15.

In the automatic travel mode, the vehicle speed sensor 19 communicates a vehicle speed signal to the CPU 39 corresponding to the detected vehicle speed. The CPU 39 compares the detected vehicle speed to the target vehicle speed set by an input device. The input device may be disposed, for example, in the vehicle 1 body. Alternatively, the input device may be disposed on a remote control device allowing the target vehicle speed to be input remotely. The CPU 39 then adjusts the driving current it supplies to the drive motor 16 by an amount corresponding to the difference between the detected vehicle speed and the target vehicle speed, so that the vehicle 1 accelerates or decelerates to the target vehicle speed if the detected vehicle speed is lower or greater than the target vehicle speed, respectively. The motor 16 generates a drive force corresponding to the driving current provided by the CPU 39 and transmits the drive force to the drive wheels 3 through the transmission 15.

Furthermore, permanent markings (not shown) disposed on the road surface are detected by the trigger sensor 52 and fixed-point sensor 53. The sensors 52, 53 communicate a marking signal to the CPU 39 to temporarily suspend a feedback control for adjusting the vehicle speed to meet the target speed or to temporarily increase the feedback control in response to the marking signal. Accordingly, the vehicle 1 can effectively operate in the automatic travel mode under various travel course conditions, such as a stop signal, road incline or decline, or a bumpy road.

According to the present embodiment, the auxiliary engine generating system 47 operates when additional power is required to drive the rear wheels 3 or when electric power generation is required to charge the battery 18. The auxiliary engine generating system 47 assists the drive motor 16 when, for example, the CPU 39 receives a pedal displacement signal from the acceleration pedal 10 that is greater than a predetermined value in the manual travel mode or a marking signal indicating a steep hill in the automatic travel mode.

The CPU 39 controls the start-up and shut-off of the engine 21 through the engine stop device 63. During start-up, the stop device 63 communicates an ignition current to ignition plugs (not shown) on the ignition system. Further, the CPU 39 communicates an ON signal to the start switch 32 to allow transmission of electric power from the battery 18 to the motor-generator 31′ through the inverter/converter 33. The motor-generator 31′ uses the electric power from the battery 18 to rotate the crankshaft 59 of the engine 21 through the transmission device 60. Accordingly, during start-up of the engine 21, the motor-generator 31′ operates as a starter motor, working in conjunction with the ignition system and the fuel supply system to start the engine 21.

During operation of the auxiliary engine generating system 47, the CPU 39 receives and engine speed signal from the engine speed sensor 62 and communicates an engine speed control signal to the throttle motor 27 to adjust the throttle valve in the carburetor 26. The carburetor 26 delivers a fuel charge including an amount of fuel from the fuel supply system to the engine 21 corresponding to the throttle valve position. The crankshaft 59 of the engine 21 drives the motor-generator 31′ at a corresponding rate through the transmission device 60 to generate electric power.

To charge the battery 18 using the engine 21, the CPU 39 also communicates and ON signal to the start switch 32 to allow transmission of the electric power generated by the motor-generator 31′ to the battery 18 through the inverter/converter 33. The inverter/converter 33 converts the electric power transmitted by the motor-generator 31′ to a form that can be used by the battery 18. For example, if the electric power transmitted by the motor-generator 31′ is in the form of an alternating current, the converter 33 converts it to a direct current before it is transmitted to the battery 18. The motor-generator 31′ also communicates a motor current and voltage signal to the CPU 39.

During operation of the auxiliary engine generating system 47 to assist the drive motor 16 drive the drive wheels 3, the CPU 39 communicates a signal to the first clutch 22 and the second clutch 61 to engage to the transmission 15 and engine 21, respectively. The torque sensor 25 communicates a signal corresponding to the torque generated by the engine 21 to the CPU 39. The CPU 39 then controls the driving current delivered to the drive motor 16 to even out any variation in torque between the motor 16 and engine 21. Thus, the vehicle 1 can travel smoothly.

In either the manual travel mode or the automatic travel mode, the drive motor 16 generates electric power during a braking operation. The electric power is then delivered to the battery 18 via the control unit 35 in the form of a regenerative current to charge the battery 18.

In the manual travel mode, the driver initiates the braking operation by pressing the brake pedal 11. The pedal 11 transmits a pedal displacement signal to the mode switching mechanism 54, which communicates the signal to the brakes 48 to implement the braking operation on the vehicle 1. Additionally, the brake switch 55 communicates a braking signal to the CPU 39 to alert the CPU 39 of the braking operation.

In the automatic travel mode, the braking operation commences when the CPU 39 receives a target vehicle speed signal from the input device that is lower than the vehicle speed detected by the vehicle speed sensor 19. Alternatively, the braking operation begins when the CPU 39 receives an emergency stop signal from the input device or a marking signal from the trigger sensor 52 and the fixed-point sensor 53 directing the CPU 39 to reduce vehicle speed. The CPU 39 then communicates a speed control signal to the brake motor 57 through the brake motor driver 58. The motor 57 subsequently drives the mode switching mechanism 54 through the gearing mechanism 56 to communicate the speed reduction signal to the brakes 48, which implement the braking operation on the wheels 2, 3 of the vehicle 1.

During the braking operation, the CPU 39 also engages the clutches 22, 61 to transmit the drive force from the transmission 15 to the motor-generator 31′ to generate electric power. The drive force is transmitted through the clutches 22, 61 and the variable transmission 24 to the crankshaft 59 of the engine 21, which subsequently drives the motor-generator 31′. Accordingly, the CPU 39 engages the clutches 22, 61 even if the auxiliary engine generating system 47 is not operated to assist the drive motor 16 drive the drive wheels 3. However, when only the motor 16 drives the wheels 3, or when the engine 21 drives the motor-generator 31 to charge the battery 18, the CPU 39 communicates a signal to the clutches 22, 61 to disengage from the transmission 15 and the engine 21, respectively.

Furthermore, during the braking operation, the braking device 66 control the braking force generated by the brakes 48, the force generated by the slowdown of the motor 16, and the motor-generator 31′. The braking device 66 communicates a control signal to the brakes 48 through the brake motor driver 58, which then transmits the signal to the brake motor 57. Likewise, the braking device 66 communicates a control signal to the motor 16 through the brake 49 as well as a control signal to the motor-generator 31.

During a normal braking operation, the inertia of the drive wheels 3 while the wheels 3 slow down generate a drive force, which is transmitted to the motor 16 through the transmission 15. The motor 16 slows down a corresponding amount, generating an amount of electric power corresponding to the drive force transmitted through the transmission 15. The motor 16 then transmits the electric power to the braking device 66, which in turn transmits it to the battery 18 in the form of a regenerative current. During slowdown of the motor 16, the CPU 39 communicates a control signal to the clutches 2, 61 to disengage the clutches 22, 61 from the transmission 15 and engine 21, respectively.

On the other hand, during a sudden braking operation, the CPU 39 communicates a control signal to the clutches 22, 61 to engage with the transmission 15 and engine 21, respectively. Accordingly, during a sudden braking operation, the inertia of the drive wheels 3 while the wheels 3 slow down generates a drive force that is also transmitted to the engine 21 through the transmission 15 to rotate the crankshaft 59, which in turn drives the motor-generator 31′. The motor-generator 31′ thus generates electric power, which is then transmitted to the battery 18 through the switch 32 and the inverter/converter 33. Therefore, during a sudden braking operation, both the motor 16 and the motor-generator 31′ generate electric power that is used to charge the battery 18.

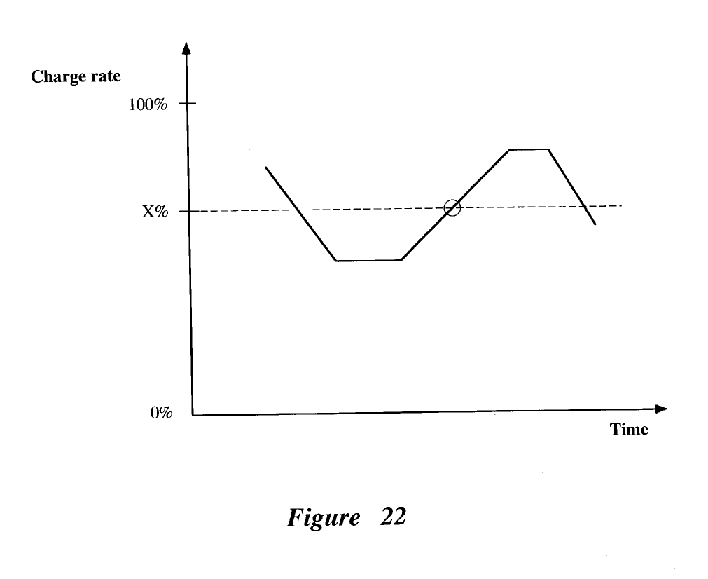

With reference to FIG. 22, a charge rate of the battery 18 according to the present embodiment is illustrated therein. If the CPU 39 receives a signal from the battery residual capacity detecting device 34 corresponding to a battery 18 charge rate that is lower than a charge rate setpoint X %, the CPU 39 initiates start-up of the engine via the engine stop device 67. As previously discussed, the CPU 39 then communicates a signal to the switch 32 to allow transmission of the electric power generated by the motor-generator 31 to the battery 18. Once the CPU 39 receives a signal from the capacity detecting device 34 corresponding to a battery 18 charge rate that is equal to the charge rate setpoint X %, the CPU 39 initiates the shut-off of the engine 21 via the stop device 67, as discussed below.

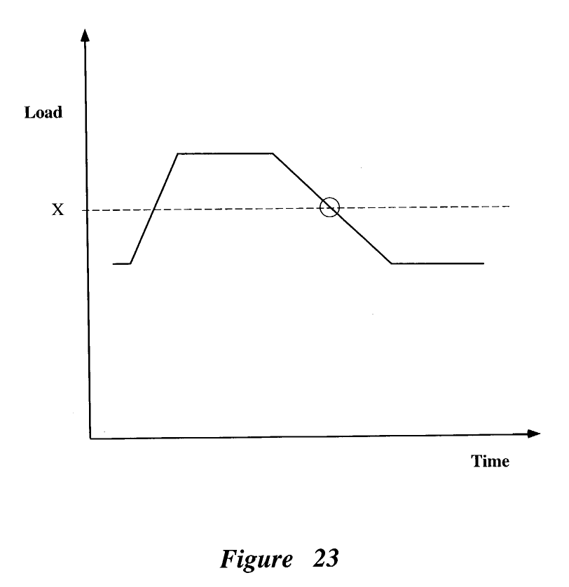

Additionally, as illustrated in FIG. 23, if the CPU 39 receives a load signal corresponding to the load applied to the drive motor 16 that is greater than a reference load setpoint X, the engine stop device 67 initiates start-up of the engine 21. Likewise, once the CPU 39 receives a load signal below the reference load setpoint X, the CPU 39 initiates the shut-off of the engine 21 via the stop device 67, as discussed below.

The load signal may correspond, for example in the automatic travel mode, to the difference between the detected vehicle speed signal transmitted from the vehicle speed sensor 19 to the CPU 39 and a target vehicle speed set by the input device. Alternatively, the load signal may correspond to the difference between a vehicle deceleration signal and a reference deceleration. Additionally, in the manual travel mode, the load signal may correspond to the difference between a rate of acceleration communicated by the driver to the CPU 39 via the displacement of the acceleration pedal 10 and a reference acceleration rate, or between a braking rate transmitted by the driver to the CPU 39 via the displacement of the brake pedal 11 and a reference braking rate. In yet another example, the load may correspond to a transmission ratio of the variable transmission 24 that is greater than a reference ratio.

To initiate shut-off of the engine 21, the stop device 67 shuts off the ignition current supplied to the ignition plugs (not shown) on the ignition system, or communicates a signal to the throttle motor 27 to fully close the throttle valve of the carburetor 26. This inhibits the carburetor 26 from delivering a fuel charge to the engine 21, thus shutting-off the engine 21 in some applications. Following initiation of engine shut-off, the stop device 67 controls the motor-generator 31′ to continue to generate electric power. Accordingly, the present embodiment allows the motor-generator 31′ to continue to generate electric power even after the charge rate of the battery 18 reaches the charge rate setpoint X % or the load reaches the reference load X, when the engine 21 is shut-off

After the stop device 67 initiates engine 21 shut-off, the inertia of the crankshaft 59, the piston and other engine components continues to produce kinetic energy, which is consumed through the continuing rotation of the motor-generator 3′ via the crankshaft 59. Once the motor-generator 31′ completely consumes the kinetic energy of the engine 21, the engine 21 comes to a complete stop. Accordingly, the motor-generator 31′ uses the kinetic energy corresponding to the inertia of the engine following engine 21 shut-off to generate electric power, which it transmits to the battery 18. Thus as illustrated in FIG. 22, if the engine is shut-off when the battery 18 charge rate reaches the charge rate setpoint X %, the battery 18 charge rate may attain a value greater than the charge rate setpoint X % with electric power generated after the engine 21 is shut-off. Therefore, according to this embodiment, the time period required for the engine 21 to charge the battery 18, and the corresponding fuel required, is reduced.

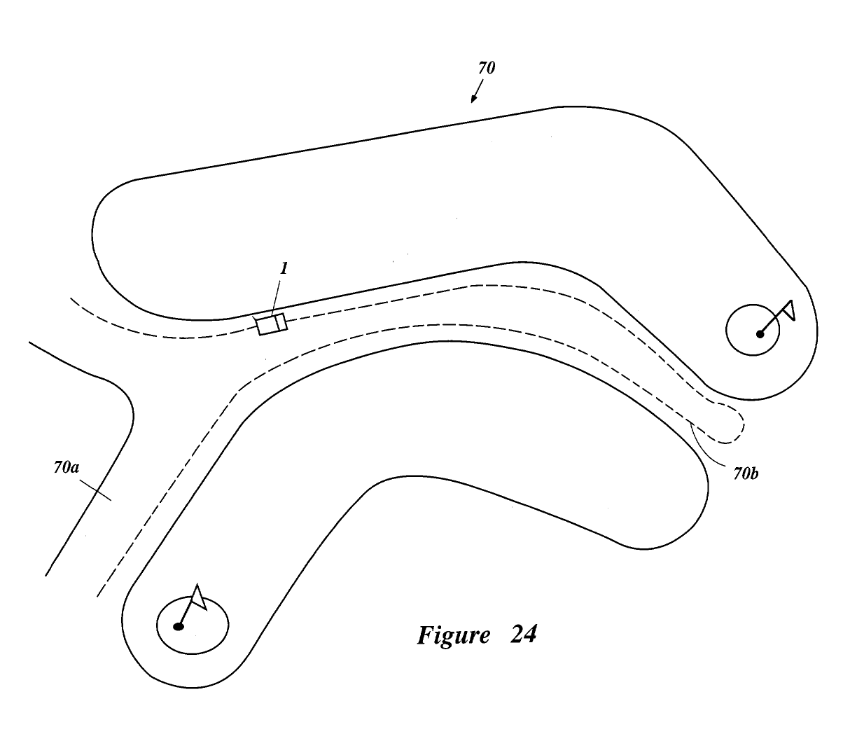

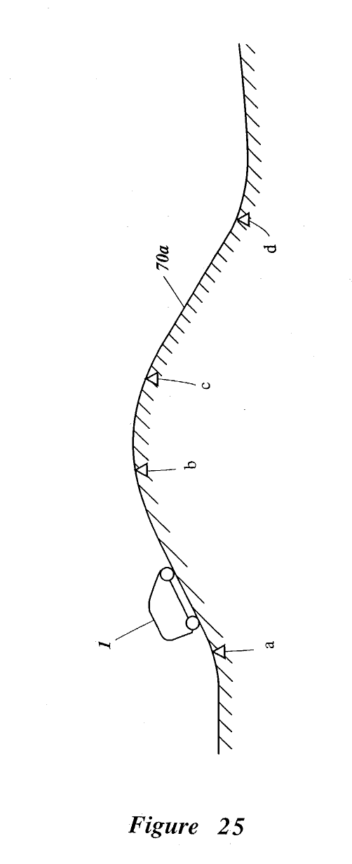

As previously described, the vehicle 1 is configured to operate in a manual travel mode and an automatic travel mode. As illustrated in FIGS. 24 and 25, the vehicle 1 operates in the manual travel mode when, for example, the vehicle is driven from a parking area (not shown) to a driving road 70a. The driving road 70a may have a variety of terrain, including flat areas, hills and dips (see “a”, “b”, and “d”, respectively, in FIG. 25). Alternatively, the vehicle 1 operates in the automatic travel mode along a pilot line 70b.

Although the present invention has been described in terms of certain embodiments, other embodiments apparent to those of ordinary skill in the art also are within the scope of this invention. Thus, various changes and modifications may be made without departing from the spirit and scope of the invention. For instance, various components may be repositioned as desired. Moreover, not all of the features, aspects and advantages are necessarily required to practice the present invention. Additionally, it is contemplated that various aspects and features of the invention described can be practiced separately, combined together, or substituted for one another, and that a variety of combination and subcombinations of the features and aspects can be made and still fall within the scope of the invention. Thus, it is intended that the scope of the present invention herein disclosed should not be limited by the particular disclosed embodiments described above, but should be determined only by a fair reading of the claims that follow.

What is claimed is:

1. A control unit for a hybrid engine having an electric motor and an internal combustion engine generating a motor drive force and an engine drive force, respectively, to drive at least one drive wheel on a hybrid vehicle, the unit comprising:
a controller communicating with the electric motor and the internal combustion engine;
a load sensor connected to the controller, the load sensor measuring an external load demand on the hybrid engine; and
a drive force sensor connected to the internal combustion engine, the drive force sensor measuring the drive force transmitted from the internal combustion engine to the at least one drive wheel.

2. The control unit of claim 1, wherein the controller selects the electric motor to drive the at least one drive wheel when the load demand is lower than a load setpoint.

3. The control unit of claim 2 further comprising:
a battery connected to the electric motor;
a generator operating between the internal combustion engine and the battery;
a clutch disposed between the internal combustion engine and a main transmission, the clutch linking the engine to the transmission, the controller communicating with the clutch; and
a battery condition sensor communicating with the battery and with the controller, the battery condition sensor measuring a battery residual capacity, wherein if the residual capacity is below a reference capacity, the controller communicates an off signal to the clutch to disengage the internal combustion engine from the main transmission and communicates a signal to the internal combustion engine to run the engine, the engine driving the generator to charge the battery.

4. The control unit of claim 1, wherein the controller selects the electric motor and the internal combustion engine to drive the at least one drive wheel when the load demand is equal to or greater than a load setpoint.

5. The control unit of claim 4, wherein the controller regulates the electric motor to decrease the motor drive force when the engine drive force measured by the drive force sensor increases at a rate equal to or greater than a rate setpoint during start-up of the internal combustion engine.

6. The control unit of claim 5 further comprising a vehicle speed sensor connected to the controller, the speed sensor measuring vehicle speed, and the controller regulating the electric motor to increase the reduction of the motor drive force if the vehicle speed is below a target vehicle speed.

7. The control unit of claim 4, wherein the controller selects the electric motor and internal combustion engine to drive the at least one drive wheel by operating a clutch disposed between the internal combustion engine and a transmission to engage the internal combustion engine to the transmission.

8. The control unit of claim 7, wherein the clutch is an electromagnetic clutch.

9. The control unit of claim 1, wherein the electric motor selectively generates electric power to charge a battery.

10. The control unit of claim 4, futher comprising:
a battery connected to the electric motor;
a generator operating between the internal combustion engine and the battery;
a motor transmission system disposed between the electric motor and the at least one drive wheel, the motor transmission system transmitting the drive force from the electric motor to the at least one drive wheel;
an engine transmission system disposed between the internal combustion engine and the at least one drive wheel, the engine transmission system transmitting the drive force from the internal combustion engine to the at least one drive wheel; and
a battery condition sensor disposed between the battery and the controller, the battery condition sensor measuring a battery capacity.

11. The control unit of claim 10, wherein if the battery capacity is equal to or greater than a reference capacity, the controller regulates the electric motor and the internal combustion engine to operate such that the ratio of the motor drive force transmitted through the motor transmission system relative to the engine drive force transmitted through the engine transmission system increases.

12. The control unit of claim 10, wherein if the residual capacity is below a reference capacity, the controller regulates the internal combustion engine to operate such that the ratio of the engine drive force transmitted from the engine to the generator relative to the engine drive force transmitted through the engine transmission system increases.

13. The control unit of claim 10 further comprising a vehicle speed sensor connected to the controller, the speed sensor measuring vehicle speed, the controller controlling the electric motor and the internal combustion engine to operate such that the drive forces transmitted through the motor transmission system and the engine transmission system increase if the vehicle speed is below a target vehicle speed.

14. The control unit of claim 1 further comprising a generator driven by the internal combustion engine, wherein the controller controls the generator to transmit a kinetic energy generated by the engine to a battery when the engine is brought to a stop.

15. The control unit of claim 14, wherein the controller comprises a braking device, the braking device regulating the generator to transmit a drive force generated by the electric motor when a clutch disposed between the internal combustion engine and the transmission engages the internal combustion engine to the transmission.

16. A control unit for a hybrid engine having an electric motor and an internal combustion engine generating a motor drive force and an engine drive force, respectively, to drive at least one drive wheel on a hybrid vehicle, the unit comprising:
a controller communicating with the electric motor and the internal combustion engine;
a load sensor connected to the controller, the load sensor measuring an external load demand on the hybrid engine; and
a start-up sensor connected to the internal combustion engine, the controller operating the electric motor to decrease the motor drive force when the start-up sensor detects the start-up of the internal combustion engine.

17. The control unit of claim 16, wherein the start-up sensor is an engine speed sensor.

18. The control unit of claim 16, wherein the controller selects the electric motor to drive the at least one drive wheel when the load demand is lower than a load setpoint.

19. The control unit of claim 16, wherein the controller causes the electric motor and the internal combustion engine to drive the at least one drive wheel when the load demand is equal to or greater than a load setpoint.

20. The control unit of claim 16 further comprising a vehicle speed sensor connected to the controller that measures vehicle speed, and the controller causing the electric motor to increase the reduction of the motor drive force if the vehicle speed is below a target vehicle speed when the internal combustion engine is started.

21. A control unit for a hybrid engine having an electric motor and an internal combustion engine generating a motor drive force and an engine drive force, respectively, to drive at least one drive wheel on a hybrid vehicle, the unit comprising:
a controller communicating with the electric motor and the internal combustion engine;
a load sensor being connected to the controller and measuring an external load demand on the hybrid engine; and
a continuously variable transmission disposed between the internal combustion engine and a transmission, wherein the variable transmission reduces the engine drive force transmitted from the internal combustion engine to the transmission during start-up of the internal combustion engine.

22. The control unit of claim 21, wherein the controller causes the electric motor to drive the at least one drive wheel independently when the load demand is lower than a load setpoint.

23. The control unit of claim 21, wherein the controller causes the electric motor and the internal combustion engine to drive the at least one drive wheel when the load demand is equal to or greater than a load setpoint.

24. The control unit of claim 21, wherein the continuously variable transmission is a V-type variable transmission.

25. The control unit of claim 4 further comprising:
a vehicle speed sensor detecting a detected vehicle speed;
a target speed input device setting a target vehicle speed;
a battery connected to the electric motor;
a generator operating between the internal combustion engine and the battery; and
a clutch disposed between the internal combustion engine and a main transmission, the clutch linking the engine to the transmission, the controller communicating with the clutch and generating a control signal to the clutch to disengage the internal combustion engine from the main transmission and a shut-off signal to the internal combustion engine if the target vehicle speed is greater than the vehicle speed detected by the vehicle speed sensor and the difference between the target vehicle speed and the detected vehicle speed is lower than a setpoint.

26. The control unit of claim 25, wherein the target speed input device comprises a memory, wherein the memory is a non-volatile memory.

27. The control unit of claim 25, wherein the target speed input device comprises a receiver.

28. The control unit of claim 25, further comprising:
a battery condition sensor communicating with the battery and the controller, the battery condition sensor measuring a battery residual capacity, wherein if the residual capacity is below a reference capacity, the controller communicates a start-up signal to the internal combustion engine to start the engine, the engine driving the generator to charge the battery.

29. The control unit of claim 25 further comprising a switch between the generator and the battery.

30. The control unit of claim 29 further comprising:
a second switch connected to the battery and the motor, wherein the electric motor selectively generates electric power to charge the battery; and
a battery condition sensor communicating with the battery and the controller, the battery condition sensor measuring a battery residual capacity, wherein if the residual capacity is greater than a reference capacity, the controller communicates an OFF signal to the switch and the second switch, and communicates a throttle control signal to the engine to reduce the throttle opening.

31. The control unit of claim 29 further comprising:
a second switch connected to the battery and the motor, wherein the electric motor selectively generates electric power to charge the battery; and
a battery condition sensor communicating with the battery and the controller, the battery condition sensor measuring a battery residual capacity, wherein if the residual capacity is lower than a reference capacity, the controller communicates an ON signal to the second switch, and communicates an OFF signal to the clutch to disengage the engine from the transmission.

32. The control unit of claim 29, further comprising a battery condition sensor communicating with the battery and the controller, the battery condition sensor measuring a battery residual capacity, wherein if the residual capacity is below a reference capacity, the controller communicates a start-up signal to the internal combustion engine to start the engine, the engine driving the generator to charge the battery, communicates an OFF signal to the clutch to disengage the internal combustion engine from the transmission, and communicates an ON signal to the switch.

33. The control unit of claim 4 further comprising:
a vehicle speed sensor detecting a detected vehicle speed;
a target speed input device setting a target vehicle speed;
a battery connected to the electric motor;
a generator operating between the internal combustion engine and the battery; and
a clutch disposed between the internal combustion engine and a main transmission, the clutch linking the engine to the transmission, the controller communicating with the clutch, and generating a control signal to the clutch to engage the internal combustion engine with the main transmission and a start-up signal to the internal combustion engine if the target vehicle speed is greater than the vehicle speed detected by the vehicle speed sensor and the difference between the target vehicle speed and the detected vehicle speed is greater than a setpoint.

34. The control unit of claim 33 further comprising a switch operating between the generator and the battery.

35. The control unit of claim 34 further comprising a battery condition sensor communicating with the battery and the controller, the battery condition sensor measuring a battery residual capacity, wherein if the residual capacity is below a reference capacity, the controller communicates an ON signal to the switch, and communicates a start-up signal to the internal combustion engine to start the engine, the engine driving the generator to charge the battery.

36. The control unit of claim 34 further comprising a battery condition sensor communicating with the battery and the controller, the battery condition sensor measuring a battery residual capacity, wherein if the residual capacity is above a reference capacity, the controller communicates an OFF signal to the switch.

37. The control unit of claim 34 further comprising:
a second switch connected to the battery and the motor, wherein the electric motor selectively generates electric power to charge the battery; and
a battery condition sensor communicating with the battery and the controller, the battery condition sensor measuring a battery residual capacity, wherein if the residual capacity is greater than a reference capacity, the controller communicates an OFF signal to the switch and the second switch, and communicates a throttle control signal to the engine to reduce the throttle opening.

38. The control unit of claim 34 further comprising:
a second switch connected to the battery and the motor, wherein the electric motor selectively generates electric power to charge the battery; and
a battery condition sensor communicating with the battery and the controller, the battery condition sensor measuring a battery residual capacity, wherein if the residual capacity is lower than a reference capacity, the controller communicates an ON signal to the second switch, and communicates an OFF signal to the clutch to disengage the engine from the transmission.

39. The control unit of claim 34, further comprising:
a battery condition sensor communicating with the battery and the controller, the battery condition sensor measuring a battery residual capacity, wherein if the residual capacity is below a reference capacity, the controller communicates an ON signal to the switch.

40. The control unit of claim 34, further comprising:
a battery condition sensor communicating with the battery and the controller, the battery condition sensor measuring a battery residual capacity, wherein if the residual capacity is greater than a reference capacity, the controller communicates an OFF signal to the switch.

41. A method for regulating the operation of a hybrid engine including an electric motor and an internal combustion engine generating a motor drive force and an engine drive force, respectively, during start-up of the engine, the method comprising the steps of:
detecting whether an external load on the hybrid engine is equal to or greater than a predetermined load, increasing the engine drive force when the external load is equal to or greater than the predetermined load; and
decreasing the motor drive force simultaneously with increasing in engine drive force.

42. A method as in claim 41, wherein the step of decreasing the motor drive force occurs when the engine drive force is increased at a rate equal to or greater than a first predetermined rate increase.

43. A method as in claim 42 additionally comprising increasing the motor drive force once the rate of engine drive force increase is equal to or less than a second predetermined rate increase.

44. A method as in claim 41, wherein the step of determining comprises sensing a vehicle speed signal, and comparing the vehicle speed signal with a target speed signal.

45. A method for regulating the operation of a hybrid engine of a vechile including an electric motor and an internal combustion engine generating a motor drive force and an engine drive force, respectively, the method comprising:
starting the internal combustion engine to generate an engine drive force; and
decreasing the motor drive force when starting the engine.

46. A method as in claim 45 additionally comprising detecting whether an external load on the hybrid engine is equal to or greater than a predetermined load, and starting the internal combustion engine when the external load is equal to or greater than the predetermined load.

47. A method as in claim 46, wherein the step of determining comprises sensing a vehicle speed signal, and comparing the vehicle speed signal with a target speed signal.

48. A method as in claim 46 additionally comprising increasing the motor drive force once the rate of engine has started and at least a portion of the engine drive force propels the vehicle.
